(19) United States
(12) Patent Application Publication
(10) Pub. No.: US 2025/0099310 A1
(43) Pub. Date: Mar. 27, 2025

(54) WHEELCHAIR

(71) Applicant: MAZDA MOTOR CORPORATION, Hiroshima (JP)

(72) Inventors: Takashi IWASE, Hiroshima (JP); Noboru KATO, Hiroshima (JP); Haruo OHE, Hiroshima (JP); Isao TODA, Hiroshima (JP)

(73) Assignee: MAZDA MOTOR CORPORATION, Hiroshima (JP)

(21) Appl. No.: 18/893,342

(22) Filed: Sep. 23, 2024

(30) Foreign Application Priority Data
Sep. 25, 2023 (JP) 2023-160030

(51) Int. Cl. A61G 5/08

(52) U.S. Cl. CPC A61G 5/0875; A61G 5/0816

(57) ABSTRACT

To facilitate attachment of a seat and suppress rattling of the attached seat, a seat frame is provided with a frame abutment section that abuts a side frame from one side in a left-right direction; an abutment member that abuts the side frame from the other side in the left-right direction; and a shaft member that supports the abutment member in a manner to allow rotation thereof about an axis extending in a body front-rear direction with respect to a body portion of the seat frame. The side frame includes a convex section that protrudes upward, the convex section pressing the abutment member from below during attachment of the seat frame and thereby causing the abutment member to rotate in a direction in which a portion of the abutment member below the axis abuts the side frame.

### TECHNICAL FIELD

The present disclosure relates to a folding wheelchair that is configured to be foldable.

### BACKGROUND ART

In general, folding wheelchairs configured to be foldable when not in use have been known (for example, see JP2022-114838A). In the wheelchair disclosed in JP2022-114838A, a left support arm is rotatably coupled to a left side frame, to which a left drive wheel is attached, and a right support arm is rotatably coupled to a right side frame, to which a right drive wheel is attached. When the wheelchair is unfolded from a folded state, the left support arm and the right support arm rotate rearward. In this way, a distance between the left side frame and the right side frame is reduced, and thus the wheelchair can be made compact.

In the wheelchair disclosed in JP2022-114838A, a seat before being folded has to be detached from the left side frame and the right side frame. Thus, the seat is attachable/detachable to/from both of the side frames. More specifically, pins, each of which protrudes forward from a seat frame, are inserted in insertion holes formed in both of the side frames. In this way, the seat is fixed to both of the side frames. Meanwhile, the seat can be detached from both of the side frames by retracting the pins.

### SUMMARY

However, as in JP2022-114838A, in the case where such a structure is adopted that the pins, each of which advances from the seat frame, are inserted in the insertion holes of the side frames, an operation to switch the pins from a retracted state to an advanced state has to be performed when the seat is attached. Thus, time and effort are required to attach the seat.

In addition, the pins cannot be inserted smoothly unless an outer diameter of each of the pins is set to be smaller than an inner diameter of the insertion hole. However, when the outer diameter of each of the pins is set to be smaller than the inner diameter of the insertion hole, such a problem occurs that the seat is likely to rattle against the side frames.

The present disclosure has been made in view of such a point, and accordingly allows easy attachment of a seat and to suppress rattling of the attached seat.

In order to achieve the above purpose, a first aspect of the present disclosure can assume a folding wheelchair including a seat on which a wheelchair user can be seated. The wheelchair includes: a left side frame that axially supports a drive wheel on a left side of a body; a right side frame that axially supports a drive wheel on a right side of the body; and a support arm that couples the left side frame and the right side frame and is foldable. The seat has a seat frame that is configured to be attachable to the left side frame and the right side frame from above. The seat frame is provided with a frame abutment section that abuts at least one side frame of the left side frame and the right side frame from one side in a left-right direction; an abutment member that abuts the one of the side frames from the other side in the left-right direction; and a shaft member that supports the abutment member in a manner to allow rotation of the abutment member about an axis extending in a body front-rear direction with respect to a body portion of the seat frame.

The one of the side frames is provided with a convex section in a manner to protrude upward, the convex section pressing the abutment member from below during attachment of the seat frame and thereby causing the abutment member to rotate in a direction in which a portion of the abutment member below the axis abuts the one of the side frames.

With this configuration, when the seat frame is attached to the side frame, the convex section of the side frame presses the abutment member of the seat frame from below. Since the abutment member that is pressed from below is supported to be rotatable about the axis extending in the body front-rear direction with respect to the body portion of the seat frame. Thus, the abutment member rotates in the direction in which the lower portion of the abutment member abuts the side frame. As a result, the frame abutment section and the abutment member of the seat frame hold the side frame in the left-right direction. Accordingly, there is no need to switch a pin from a retracted state to an advanced state as in the related art, the attachment of the seat is facilitated, a clearance is unlikely to be provided between the seat frame and the side frame, and rattling of the seat is thereby suppressed.

The convex section according to a second aspect of the present disclosure is disposed to press a portion of the abutment member on one side in the left-right direction of the axis during the attachment of the seat frame.

With this configuration, since the portion pressing the abutment member in the convex portion is the portion on the one side in the left-right direction rather than the axis. Thus, a downward pressing force by the convex section is applied such that the portion of the abutment member below the axis abuts the side frame from the other side in the left-right direction. In this way, the abutment member can reliably abut the side frame.

The seat frame according to a third aspect of the present disclosure is provided with an urging member that constantly urges the abutment member in a direction away from the frame abutment section.

With this configuration, in a state where the seat is not attached, the abutment member rotates in the direction away from the side frame by the urging force generated by the urging member. Thus, when the seat is attached, the seat frame can easily be inserted between the frame abutment section and the abutment member.

The abutment member according to a fourth aspect of the present disclosure may extend to a position below the one of the side frames along a side surface of the one of the side frames. In this case, a lower end portion of the abutment member can be formed with a protruding section that is disposed to protrude to one side in the left-right direction and oppose a lower surface of the one of the side frames.

With this configuration, when the side frame, which is held by the frame abutment section and the abutment member, moves downward to be removed from the position between the frame abutment section and the abutment member in the attachment state of the seat, the protruding section of the abutment member is disposed to oppose the lower surface of the side frame. Thus, the lower surface of the side frame contacts the protruding section. This ensures that the side frame is not unexpectedly removed from the position between the frame abutment section and the abutment member.

In a fifth aspect of the present disclosure, a predetermined space is provided between the protruding section of the abutment member and the lower surface of the one of the side frames.

With this configuration, the predetermined space is provided between the protruding section of the abutment member and the lower surface of the side frame in the state where the seat is attached. Thus, when it is attempted to detach the seat, the seat frame can be lifted with respect to the side frame by the space. As a result, the abutment member rotates in the direction away from the side frame by the urging force of the urging member. Thus, the seat frame can easily be detached from the side frame.

The urging member according to a sixth aspect of the present disclosure can be formed of a coil spring that is disposed between the frame abutment section and the abutment member in a manner that a compression direction is oriented in the left-right direction. In this case, an intermediate portion of the convex section in the body front-rear direction can be formed with a notched section in which an intermediate portion of the coil spring in the left-right direction can be accommodated.

With this configuration, the abutment member can be urged in a desired direction by a simple configuration of using the coil spring that can be compressed or extended in the left-right direction. In this case, it is possible to avoid interference between the convex section of the side frame and the coil spring.

As it has been described so far, when the seat is attached, the side frame is held in the left-right direction by causing the rotation of the abutment member. Therefore, it is possible to easily attach the seat and suppress rattling of the attached seat.

### BRIEF DESCRIPTION OF THE DRAWINGS

FIG. 1 is a perspective view in which a wheelchair according to an embodiment of the present disclosure is seen from the front.

FIG. 2 is a perspective view in which the wheelchair, from which a seat is detached, is seen from the front.

FIG. 3 is a front view of the wheelchair, from which the seat is detached.

FIG. 4 is a left side view of the seat.

FIG. 5 is a perspective view in which a folded wheelchair body is seen from above.

FIG. 6 is a front view of the folded wheelchair body.

FIG. 7 is a right side view of a left side frame.

FIG. 8 is a left side view of a right side frame.

FIG. 9 is an enlarged plan view of an area including a footrest, a rod, and a support arm in an unfolded state.

FIG. 10 is a cross-sectional view that is taken along line X-X in FIG. 2.

FIG. 11 is a cross-sectional view that is taken along line XI-XI in FIG. 2.

FIG. 12 is a view of the wheelchair body in a folded state and corresponding to FIG. 10.

FIG. 13 is a perspective view in which the wheelchair body in the folded state is seen from a left side and in which the left side frame and a wheel are not illustrated.

FIG. 14 is a view in which the wheelchair body in the folded state is seen from the left side and in which the left side frame and the wheel are not illustrated.

FIG. 15 is a view illustrating a positional relationship among arm components in the unfolded state.

FIG. 16 is a view illustrating the positional relationship among the arm components in the folded state.

FIG. 17 is a front view illustrating a lower arm component and an engaged plate in the unfolded state.

FIG. 18 is a view in which an engagement section, which is attached to an upper coupling member, is seen from behind.

FIG. 19 is a plan view of the seat.

FIG. 20 is a back view of the seat.

FIG. 21 is an enlarged perspective view of a right portion of the wheelchair in which a seat cushion section is not illustrated.

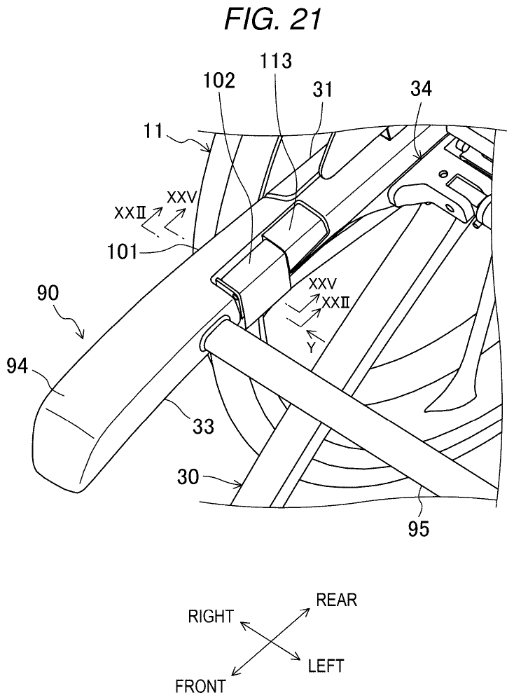

FIG. 22 is a cross-sectional view that is taken along line XXII-XXII in FIG. 21.

FIG. 23 is a view in a direction of an arrow Y in FIG. 21.

FIG. 24 is a view illustrating a state where an abutment member rotates in a direction away from a frame abutment section and corresponding to FIG. 22.

FIG. 25 is a cross-sectional view that is taken along line XXV-XXV in FIG. 21.

FIG. 26 is a view in which a right frame section of a seat frame is seen from above, and is a view illustrating a partial cross section.

FIG. 27 is a side view of a seat support plate section.

FIG. 28 is a view in which a part of a seat back section is seen from behind.

### DETAILED DESCRIPTION

A detailed description will hereinafter be made on an embodiment of the present disclosure with reference to the drawings. The following description on a preferred embodiment is essentially and merely illustrative and thus has no intention to limit the present disclosure, application subjects thereof, and application thereof.

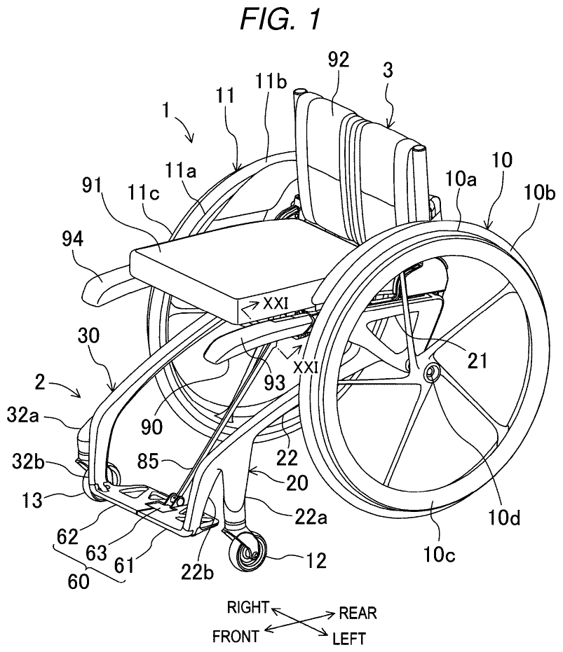

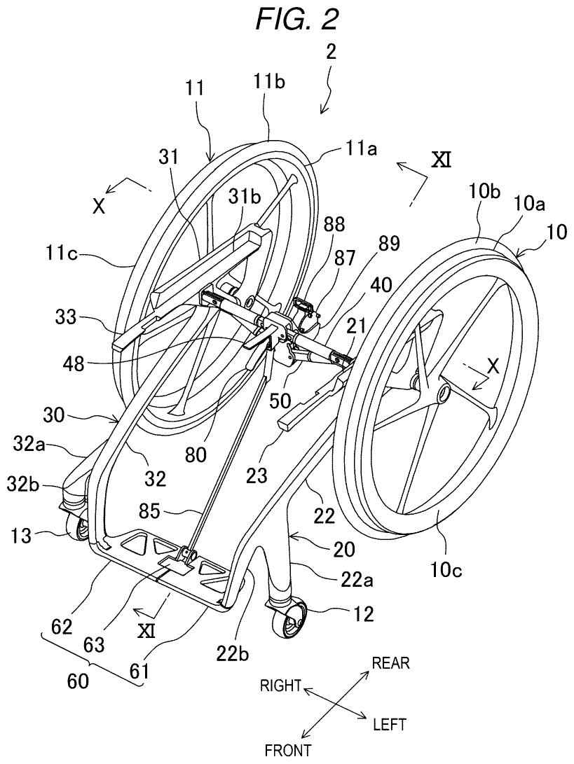

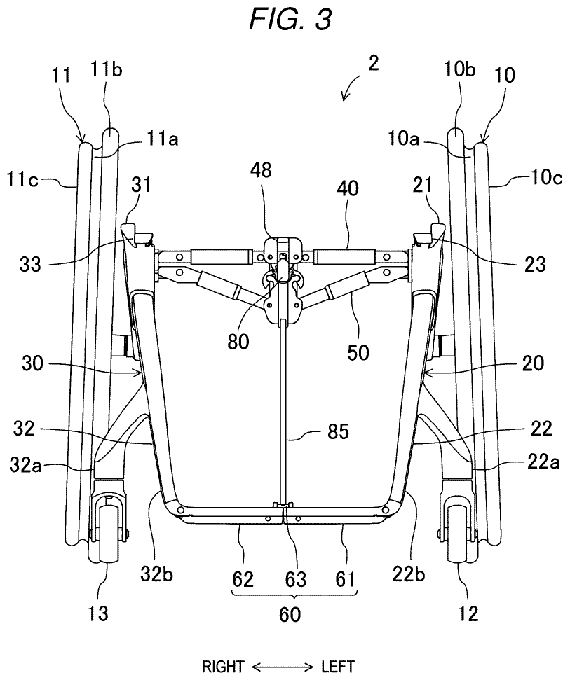

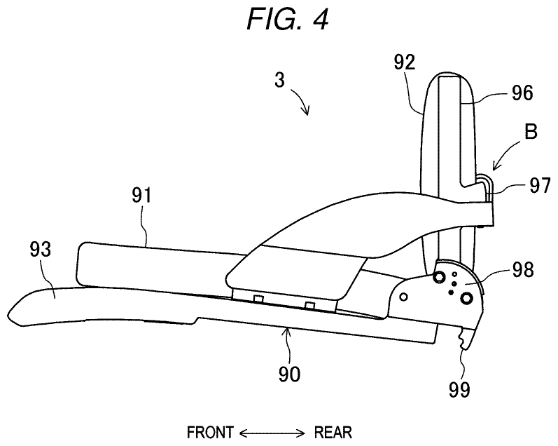

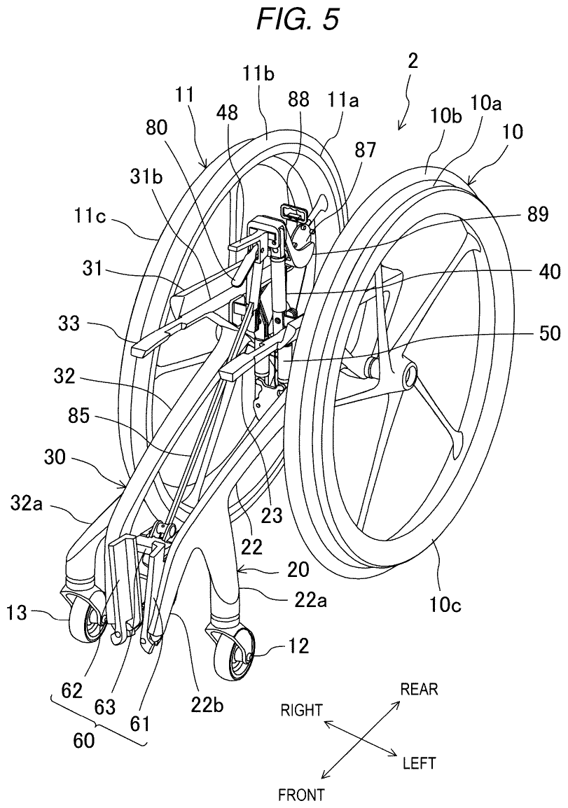

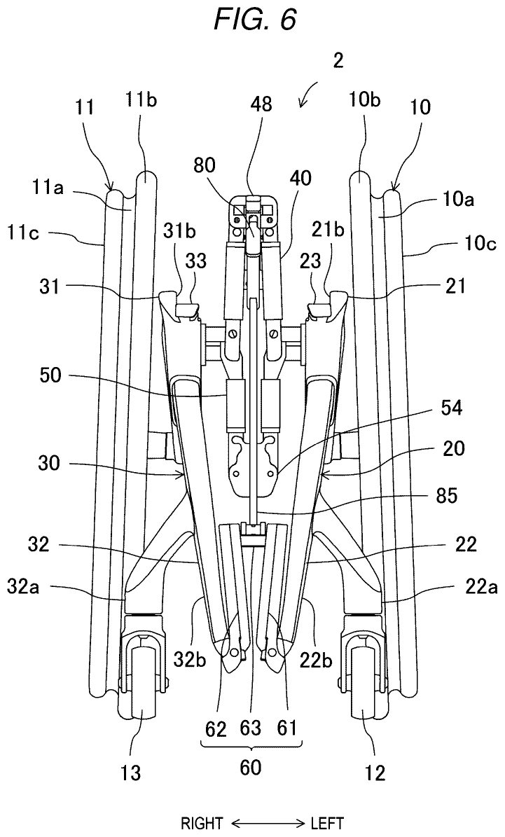

FIG. 1 is a perspective view in which a wheelchair 1 according to the embodiment of the present disclosure is seen diagonally upward from the front. As illustrated in FIG. 2 and FIG. 3, this wheelchair 1 is a wheelchair configured that a seat 3 can be detached from a wheelchair body 2 without the need for a tool. FIG. 4 is a left side view of the seat 3 that is detached from the wheelchair body 2. As illustrated in FIG. 5 and FIG. 6, the wheelchair body 2 in a detachment state of the seat 3 is configured to be foldable. Thus, the wheelchair 1 according to this embodiment is a folding wheelchair on which a wheelchair user can be seated.

In the description of this embodiment, an advancing direction of the wheelchair 1 during forward travel is simply referred to as the front, and a front side of the wheelchair 1 corresponds to a front side of the wheelchair user (not illustrated) who is seated on the wheelchair 1. In addition, an advancing direction of the wheelchair 1 during rearward travel is simply referred to as the rear, and a rear side of the wheelchair 1 corresponds to a rear side of the wheelchair user who is seated on the wheelchair 1. A front-rear direction of the wheelchair 1 is also a longitudinal direction of a body. A left side of the wheelchair user who is seated on the wheelchair 1 is a left side of the body of the wheelchair 1 and is simply referred to as the left. Furthermore, a right side of the wheelchair user who is seated on the wheelchair 1 is a right side of the body of the wheelchair 1 and is simply referred to as the right. A left-right direction of the wheelchair 1 is a width direction of the body and is also referred to as a body width direction. An “upper side” of the wheelchair 1 is a side that becomes the upper side when the wheelchair 1 in a seating position is placed on a horizontal surface, and a “lower side” of the wheelchair 1 is a side that becomes the lower side when the wheelchair 1 in the seating position is placed on the horizontal surface.

### Configuration of Wheelchair Body

As illustrated in FIG. 1, FIG. 2, and the like, the wheelchair body 2 includes left and right drive wheels 10, 11, left and right casters 12, 13, left and right side frames 20, 30, upper and lower support arms 40, 50, and a footrest 60. The left drive wheel 10 is axially supported on the left side frame 20, and the right drive wheel 11 is axially supported on the right side frame 30. In addition, the left side frame 20 and the right side frame 30 are coupled by the upper support arm 40 and the lower support arm 50. By folding the upper support arm 40, the lower support arm 50, and the footrest 60, as illustrated in FIG. 5 and FIG. 6, the wheelchair 1 can be brought into a folded state.

The drive wheels 10, 11 are large-diameter wheels that are hand-held and rotated forward or rearward by the wheelchair user who is seated on the seat 3, and can also be referred to as drive rear wheels as being provided on a rear side of the wheelchair body 2. Although structures of the drive wheels 10, 11 are not particularly limited, in this embodiment, the drive wheels 10, 11 are structured that rubber tires 10b, 11b are respectively attached to wheels 10a, 11a, each of which is molded of carbon fiber-reinforced plastics (CFRP). Hand rims 10c, 11c that are hand-held by the wheelchair user during driving are respectively provided on outer sides of the wheels 10a, 11a in the body width direction. Although not illustrated, the wheelchair 1 is provided with a brake. The brake is configured to be manually operable by the wheelchair user who is seated on the seat 3. More specifically, the brake generates a braking force by contacting the tires 10b, 11b. Such a brake has been well known conventionally.

The casters 12, 13 are wheels for changing the advancing direction of the wheelchair 1 and have smaller diameters than the drive wheels 10, 11. Since the casters 12, 13 are provided on the front side of the wheelchair body 2, the casters 12, 13 can also be referred to as front wheels for changing the advancing direction.

### Configurations of Side Frames

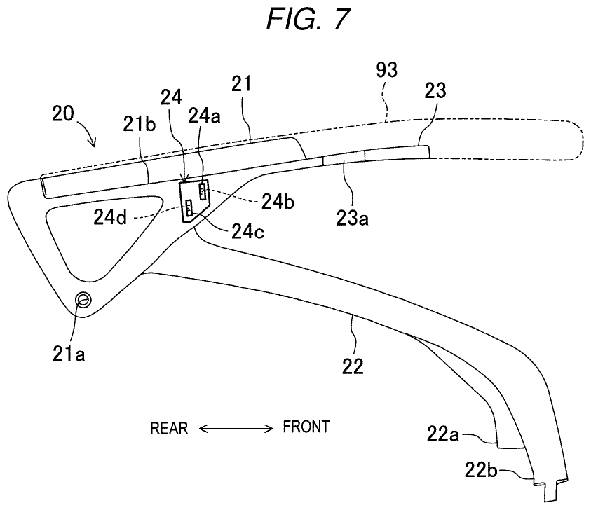

As illustrated in FIG. 2, the left side frame 20 includes an upper frame section 21 that extends in the front-rear direction and a caster support section 22. FIG. 7 illustrates the left side frame 20 when the wheelchair 1 is placed on the horizontal surface. As illustrated in FIG. 7, the upper frame section 21 is gently inclined upward to the front. An inclination angle of the upper frame section 21 may not be the illustrated angle and may be horizontal. The upper frame section 21 and the caster support section 22 are integrally molded of the CFRP. Thus, the left side frame 20 is configured as a single component. Here, the left side frame 20 may be formed of a metal material or may be formed by joining plural components.

A rear end portion of the upper frame section 21 is formed with an axle insertion hole 21a in which a right portion of an axle 10d (illustrated in FIG. 1) provided to the left drive wheel 10 is fixedly inserted. In a state where the right portion of the axle 10d is fixed to the rear end portion of the upper frame section 21, the left drive wheel 10 is axially supported on the left side frame 20 in a manner to be rotatable about an axis extending in the left-right direction.

A left seat frame accommodation section 21b in a concave shape is formed in a right portion of the upper frame section 21. In the left seat frame accommodation section 21b, a rear portion of a left frame section 93 (indicated by an imaginary line) provided to the seat 3 is accommodated. In a portion of the upper frame section 21 other than the rear end portion, the left seat frame accommodation section 21b is formed continuously in the front-rear direction. The left seat frame accommodation section 21b is opened upward and rightward, is also opened forward, and can thereby accommodate the rear portion of the left frame section 93 from above.

As indicated by the imaginary line in FIG. 7, a front portion of the left frame section 93 is disposed to protrude forward from the left seat frame accommodation section 21b. The upper frame section 21 is provided with a seat support plate section 23 for supporting an intermediate portion of the left frame section 93 in the front-rear direction from below. The seat support plate section 23 has an elongated plate shape that extends forward, and constitutes a part of the left side frame 20. A front end portion of the seat support plate section 23 is located behind a front end portion of the left frame section 93. A concave section 23a is provided on a right surface (an inner surface in the body width direction) of an intermediate portion of the seat support plate section 23 in the front-rear direction.

The left side frame 20 has an arm coupling member 24. The arm coupling member 24 is a member that is fixed to a right surface (a surface located on the inner side in the body width direction) of an intermediate portion of the left side frame 20 in the front-rear direction and to which left end portions of the upper support arm 40 and the lower support arm 50 are coupled. An upper protruding plate section 24a that extends in an up-down direction is provided to an upper portion of the arm coupling member 24 in a manner to protrude rightward. The upper protruding plate section 24a is formed with an upper through hole 24b that penetrates the upper protruding plate section 24a in the front-rear direction. A lower protruding plate section 24c that extends in the up-down direction is provided to a lower portion of the arm coupling member 24 in a manner to protrude rightward. The lower protruding plate section 24c is positioned behind the upper protruding plate section 24a. The lower protruding plate section 24c is formed with a lower through hole 24d that penetrates the lower protruding plate section 24c in the front-rear direction.

The caster support section 22 is formed to extend forward and is lowered toward a front end. A caster attachment section 22a is provided to a front end portion of the caster support section 22 in a manner to protrude downward. To the caster attachment section 22a, the left caster 12 is attached to be turnable about an axis that extends in the up-down direction. Furthermore, a footrest support section 22b that supports the footrest 60 described below is provided to the front end portion of the caster support section 22 in a manner to protrude downward. As illustrated in FIG. 3, the footrest support section 22b is located on the right side (the inner side in the body width direction) of the caster attachment section 22a.

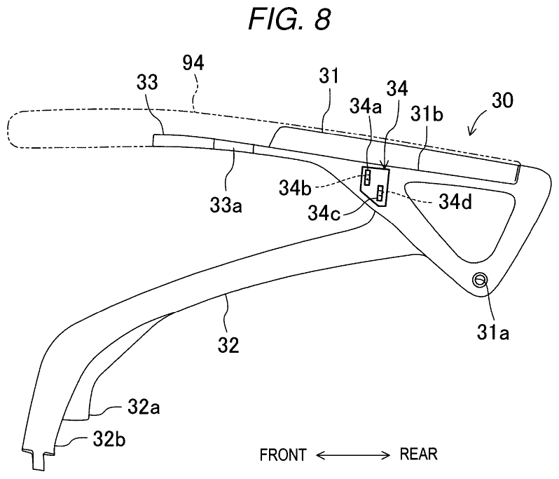

The right side frame 30 has a shape that is bilaterally symmetrical to the left side frame 20. More specifically, as illustrated in FIG. 8, the right side frame 30 includes an upper frame section 31 and a caster support section 32.

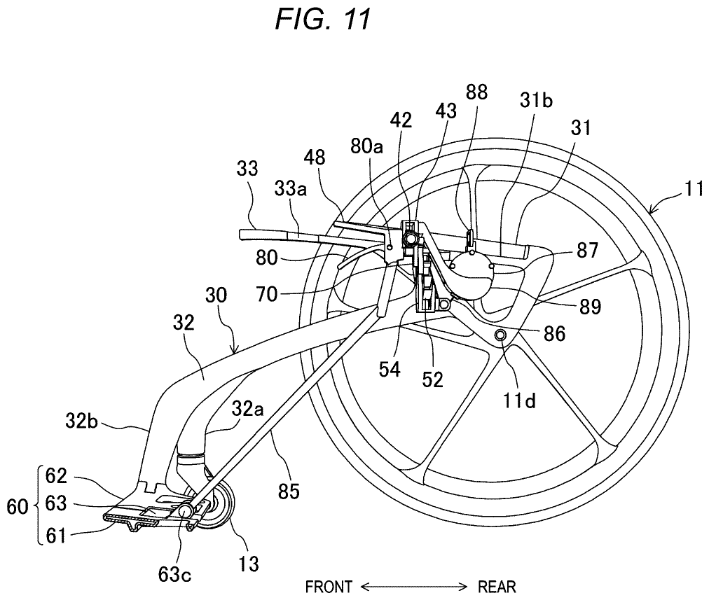

A rear end portion of the upper frame section 31 of the right side frame 30 is formed with an axle insertion hole 31a in which a left portion of an axle 11d (illustrated in FIG. 11) provided to the right drive wheel 11 is fixedly inserted. In a state where the left portion of the axle 11d is fixed to the rear end portion of the upper frame section 31, the right drive wheel 11 is axially supported on the right side frame 30 in a manner to be rotatable about an axis extending in the left-right direction.

A right seat frame accommodation section 31b in a concave shape is formed in a left portion of the upper frame section 31 of the right side frame 30. In the right seat frame accommodation section 31b, a rear portion of a right frame section 94 (indicated by an imaginary line) provided to the seat 3 is accommodated. In a portion of the upper frame section 31 other than the rear end portion, the right seat frame accommodation section 31b is formed continuously in the front-rear direction. The right seat frame accommodation section 31b is opened upward and leftward, is also opened forward, and can thereby accommodate the rear portion of the right frame section 94 from above.

As indicated by the imaginary line in FIG. 8, a front portion of the right frame section 94 is disposed to protrude forward from the right seat frame accommodation section 31b. The upper frame section 31 is provided with a seat support plate section 33 for supporting an intermediate portion of the right frame section 94 in the front-rear direction from below. The seat support plate section 33 has an elongated plate shape that extends forward, and constitutes a part of the right side frame 30. A front end portion of the seat support plate section 33 is located behind a front end portion of the right frame section 94. A concave section 33a is provided on a left surface of an intermediate portion of the seat support plate section 33 in the front-rear direction.

The right side frame 30 has an arm coupling member 34. The arm coupling member 34 is a member that is fixed to a left surface (a surface positioned on the inner side in the body width direction) of an intermediate portion of the right side frame 30 in the front-rear direction and to which right end portions of the upper support arm 40 and the lower support arm 50 are coupled. An upper protruding plate section 34a that extends in the up-down direction is provided to an upper portion of the arm coupling member 34 in a manner to protrude leftward. The upper protruding plate section 34a is formed with an upper through hole 34b that penetrates the upper protruding plate section 34a in the front-rear direction. A lower protruding plate section 34c that extends in the up-down direction is provided to a lower portion of the arm coupling member 34 in a manner to protrude leftward. The lower protruding plate section 34c is located behind the upper protruding plate section 34a. The lower protruding plate section 34c is formed with a lower through hole 34d that penetrates the lower protruding plate section 34c in the front-rear direction.

The caster support section 32 of the right side frame 30 is formed to extend forward and is lowered toward a front end. A caster attachment section 32a is provided to a front end portion of the caster support section 32 in a manner to protrude downward. To the caster attachment section 32a, the right caster 13 is attached to be turnable about an axis that extends in the up-down direction. Furthermore, a footrest support section 32b that supports the footrest 60 described below is provided to the front end portion of the caster support section 32 in a manner to protrude downward. As illustrated in FIG. 3, the footrest support section 32b is located on the left side (the inner side in the body width direction) of the caster attachment section 32a.

### Configuration of Footrest

As illustrated in FIG. 1, the footrest 60 for the wheelchair user who is seated on the seat 3 to place his/her feet is provided to a front portion of the wheelchair body 2. The footrest 60 is configured to couple the footrest support section 22b, which is a front end portion of the left side frame 20, and the footrest support section 32b, which is a front end portion of the right side frame 30, and to be foldable in a central portion in the left-right direction.

In other words, the footrest 60 has a three-part structure having: a left footrest component 61 that constitutes a left portion of the footrest 60; a right footrest component 62 that constitutes a right portion of the footrest 60; and a bracket 63 that couples a right end portion of the left footrest component 61 and a left end portion of the right footrest component 62 in a manner to allow rotation thereof. The bracket 63 is disposed in the central portion of the footrest 60 in the left-right direction. Each of the left footrest component 61 and the right footrest component 62 is formed of a plate material, and the left footrest component 61 and the right footrest component 62 constitute a plate-shaped foot placement section that extends in the left-right direction.

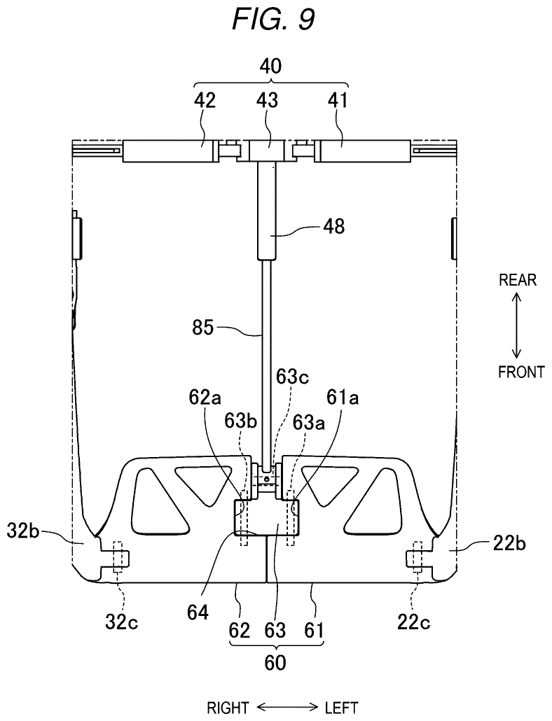

FIG. 9 is a plan view of the footrest 60. A left coupling shaft 22c that extends in the front-rear direction is supported by the left footrest support section 22b. A left end portion of the left footrest component 61 is coupled to the left footrest support section 22b via the left coupling shaft 22c. The left footrest component 61 is rotatable in the up-down direction about an axis of the left coupling shaft 22c. The left coupling shaft 22c may rotate with respect to the footrest support section 22b, or the left footrest component 61 may rotate with respect to the left coupling shaft 22c.

Similar to the left coupling shaft 22c side, a right coupling shaft 32c that extends in the front-rear direction is supported by the right footrest support section 32b. A right end portion of the right footrest component 62 is coupled to the right footrest support section 32b via the right coupling shaft 32c. The right footrest component 62 is rotatable in the up-down direction about an axis of the right coupling shaft 32c.

The right end portion of the left footrest component 61 is formed with a left notch section 61a in a central portion in the front-rear direction. The left end portion of the right footrest component 62 is also formed with a right notch section 62a in a central portion in the front-rear direction. The left notch section 61a and the right notch section 62a are aligned in the front-rear direction. Thus, an opening 64 is formed between the right end portion of the left footrest component 61 and the left end portion of the right footrest component 62 by both of the notch sections 61a, 62a.

A first coupling shaft 63a that extends in the front-rear direction is supported by a left portion of the bracket 63. The right end portion of the left footrest component 61 is rotatably coupled to the bracket 63 via the first coupling shaft 63a. In addition, a second coupling shaft 63b that extends in the front-rear direction is supported by a right portion of the bracket 63. The left end portion of the right footrest component 62 is rotatably coupled to the bracket 63 via the second coupling shaft 63b.

When the footrest 60 is unfolded, the bracket 63 is disposed in the opening 64 that is formed between the right end portion of the left footrest component 61 and the left end portion of the right footrest component 62. Then, when the footrest 60 is unfolded, the bracket 63 is held between the left footrest component 61 and the right footrest component 62 from both of the left and right sides. More specifically, the bracket 63 is formed such that a left end portion abuts an edge of the left notch section 61a of the left footrest component 61 when the footrest 60 is unfolded. In addition, the bracket 63 is formed such that a right end portion abuts an edge of the right notch section 62a of the right footrest component 62 when the footrest 60 is unfolded.

Just as described, the footrest 60 has the three-part structure. The left footrest component 61 is coupled to the footrest support section 22b in the manner to be rotatable in the up-down direction, the right footrest component 62 is coupled to the footrest support section 32b in the manner to be rotatable in the up-down direction, and the bracket 63 is coupled to the left footrest component 61 and the right footrest component 62 in a manner to be rotatable relative to the left footrest component 61 and the right footrest component 62. Thus, the footrest 60 can be switched from an unfolded state (a usable state) illustrated in FIG. 1 and the like to a folded state (an unusable state) illustrated in FIG. 5 and the like, and vice versa. When the footrest 60 is folded the transition is made from the unfolded state to the folded state, the left footrest component 61 and the right footrest component 62 rotate upward such that the footrest 60 defines a shape forming a convexity in the up direction. When the footrest 60 is unfolded the transition is made from the folded state to the unfolded state, the left footrest component 61 and the right footrest component 62 rotate downward such that the footrest 60 takes a posture extending in the left-right direction. In other words, a folding direction and an unfolding direction of the footrest 60 match the up-down direction. Thus, the footrest 60 does not interfere with folding and unfolding of the wheelchair 1.

A rear end portion of the bracket 63 protrudes higher than upper surfaces of the left footrest component 61 and the right footrest component 62, and this upward protruding portion supports a third coupling shaft 63c that extends in the left-right direction. The third coupling shaft 63c is a member for coupling a lower end portion of a rod 85, which will be described below, to the bracket 63.

### Structures of Upper Support Arm and Lower Support Arm

The wheelchair body 2 is configured that the wheelchair body 2 can be brought into the folded state illustrated in FIG. 5 and FIG. 6 from the unfolded state illustrated in FIG. 1 to FIG. 3 and can be brought into the unfolded state from the folded state without using the tool or the like. In the unfolded state, a distance between the left side frame 20 and the right side frame 30 is increased, which enables attachment of the seat 3. Meanwhile, in the folded state, the distance between the left side frame 20 and the right side frame 30 is reduced, which prevents the attachment of the seat 3.

In this embodiment, the seat 3 is configured to be attachable/detachable to/from the wheelchair body 2. Accordingly, when the wheelchair 1 is not in use, the seat 3 is detached from the wheelchair body 2, and the seat 3 and the wheelchair body 2 thereby separate from each other. As a result, the seat 3 and the wheelchair body 2 can separately be carried due to light weight and can also be made compact. In addition, since the wheelchair body 2 can be folded, the wheelchair body 2 becomes compact. Hereinafter, as a structure that makes the wheelchair body 2 foldable, the upper support arm 40 and the lower support arm 50 will be described in detail.

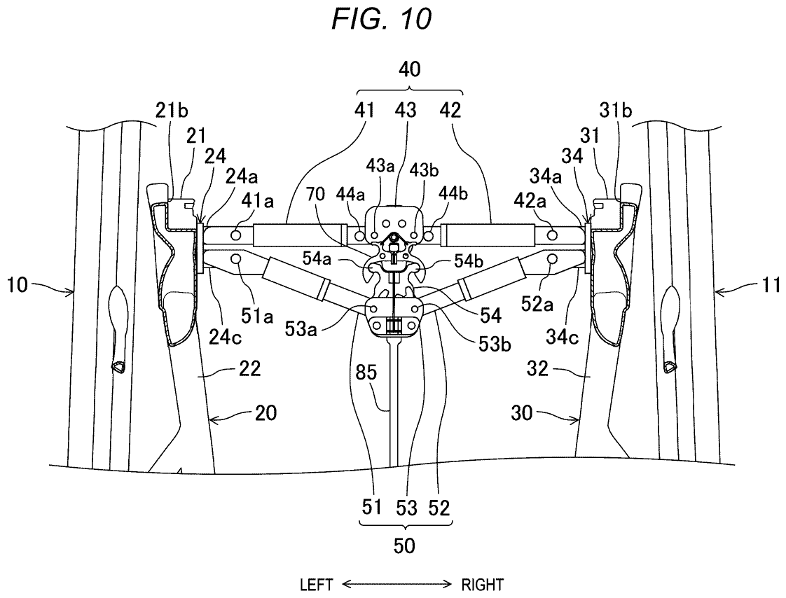

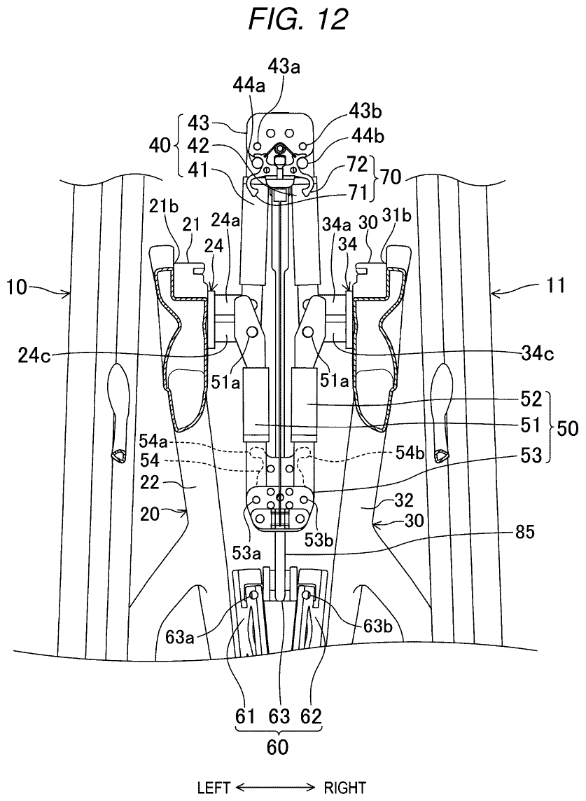

As illustrated in FIG. 10 to FIG. 14, the upper support arm 40 is formed of plural members, couples the left side frame 20 and the right side frame 30, and is folded in the up-down direction in a central portion thereof in the left-right direction (a longitudinal direction). The lower support arm 50 couples the left side frame 20 and the right side frame 30, is folded in the up-down direction in a central portion thereof in the left-right direction (a longitudinal direction), and is provided below the upper support arm 40. The lower support arm 50 is also formed of plural members. Here, the number of the support arms is not limited two.

As illustrated in FIG. 10, the upper support arm 40 is configured to extend in the left-right direction when in the unfolded state. The upper support arm 40 is located right below the seat 3. However, since the upper support arm 40 extends in a substantially horizontal direction, the upper support arm 40 does not interfere with a cushion portion of the seat 3 when the wheelchair user is seated. This upper support arm 40 has: a first upper arm component 41 that constitutes a left portion of the upper support arm 40; a second upper arm component 42 that constitutes a right portion of the upper support arm 40; and an upper coupling member 43 that couples a right end portion of the first upper arm component 41 and a left end portion of the second upper arm component 42 in a manner to allow rotation thereof.

The lower support arm 50 is configured to be positioned higher toward a left end and toward a right end when in the unfolded state. In other words, the lower support arm 50 has such a shape that a central portion in the left-right direction protrudes downward when compared to both end portions. However, since there is an empty space between the left and right drive wheels 10, 11, the lower support arm 50 in this shape does not cause a problem when in use or the like. This lower support arm 50 has: a first lower arm component 51 that constitutes a left portion of the lower support arm 50; a second lower arm component 52 that constitutes a right portion of the lower support arm 50; and a lower coupling member 53 that couples a right end portion of the first lower arm component 51 and a left end portion of the second lower arm component 52 in a manner to allow rotation thereof. The first lower arm component 51 is disposed to be inclined such that the right end portion of the first lower arm component 51 is positioned lower than a left end portion. The second lower arm component 52 is disposed to be inclined such that the left end portion of the second lower arm component 52 is positioned lower than a right end portion.

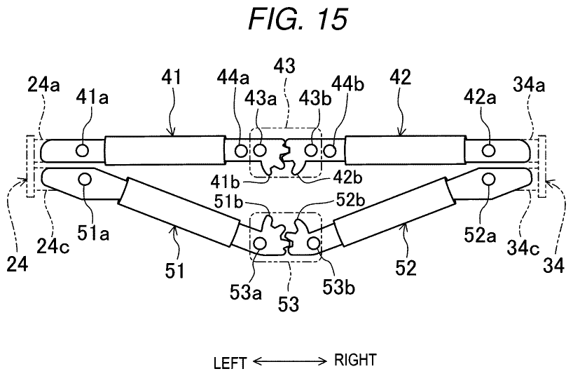

FIG. 15 illustrates a positional relationship in the unfolded state between a group including the first upper arm component 41 and the second upper arm component 42 and a group including the first lower arm component 51 and the second lower arm component 52. As illustrated in FIG. 15, in the back view (same in the front view), a distance between the upper support arm 40 and the lower support arm 50 is increased toward the central portion in the left-right direction and is reduced toward a left end and toward a right end.

A left end portion of the first upper arm component 41 is coupled to the upper protruding plate section 24a of the arm coupling member 24 of the left side frame 20 via a first upper support shaft 41a. The first upper support shaft 41a extends in the front-rear direction and is supported in an inserted state in the upper through hole 24b. The first upper support shaft 41a can rotate about an axis with respect to the left end portion of the first upper arm component 41 or can rotate about the axis with respect to the upper protruding plate section 24a. In other words, the left end portion of the first upper arm component 41 is coupled to the left side frame 20 in a manner to be rotatable about the shaft extending in the front-rear direction.

The left end portion and the right end portion of the first upper arm component 41 are end portions that respectively serve as the left end portion and the right end portion in the unfolded state and respectively serve as a lower end portion and an upper end portion in the folded state. Similarly, the left end portion and a right end portion of the second upper arm component 42 are end portions that respectively serve as the left end portion and the right end portion in the unfolded state and respectively serve as an upper end portion and a lower end portion in the folded state.

The right end portion of the second upper arm component 42 is coupled to the upper protruding plate section 34a of the arm coupling member 34 of the right side frame 30 via a second upper support shaft 42a. The second upper support shaft 42a extends in the front-rear direction and is supported in an inserted state in the upper through hole 34b. The second upper support shaft 42a can rotate about an axis with respect to the right end portion of the second upper arm component 42 or can rotate about an axis with respect to the upper protruding plate section 34a. In other words, the right end portion of the second upper arm component 42 is coupled to the right side frame 30 in a manner to be rotatable about the shaft extending in the front-rear direction.

The right end portion of the first upper arm component 41 is coupled to a left portion of the upper coupling member 43 via a third upper support shaft 43a. The third upper support shaft 43a extends in the front-rear direction and is supported by the upper coupling member 43 while penetrating the right end portion of the first upper arm component 41 in the front-rear direction. The third upper support shaft 43a can rotate about an axis with respect to the right end portion of the first upper arm component 41 or can rotate about the axis with respect to the upper coupling member 43. In other words, the right end portion of the first upper arm component 41 is coupled to the upper coupling member 43 in a manner to be rotatable about the shaft extending in the front-rear direction.

The left end portion of the second upper arm component 42 is coupled to a right portion of the upper coupling member 43 via a fourth upper support shaft 43b. The fourth upper support shaft 43b extends in the front-rear direction and is supported by the upper coupling member 43 while penetrating the left end portion of the second upper arm component 42 in the front-rear direction. The fourth upper support shaft 43b can rotate about an axis with respect to the left end portion of the second upper arm component 42 or can rotate about the axis with respect to the upper coupling member 43. In other words, the left end portion of the second upper arm component 42 is coupled to the upper coupling member 43 in a manner to be rotatable about the shaft extending in the front-rear direction.

The left end portion of the first lower arm component 51 is coupled to the lower protruding plate section 24c of the arm coupling member 24 of the left side frame 20 via a first lower support shaft 51a. The first lower support shaft 51a extends in the front-rear direction and is supported in an inserted state in the lower through hole 24d. The first lower support shaft 51a can rotate about an axis with respect to the left end portion of the first lower arm component 51 or can rotate about the axis with respect to the lower protruding plate section 24c. In other words, the left end portion of the first lower arm component 51 is coupled to the left side frame 20 in a manner to be rotatable about the shaft extending in the front-rear direction.

The left end portion and the right end portion of the first lower arm component 51 are end portions that respectively serve as the left end portion and the right end portion in the unfolded state and respectively serve as an upper end portion and a lower end portion in the folded state. Similarly, the left end portion and the right end portion of the second lower arm component 52 are end portions that respectively serve as the left end portion and the right end portion in the unfolded state and respectively serve as a lower end portion and an upper end portion in the folded state.

The right end portion of the second lower arm component 52 is coupled to the lower protruding plate section 34c of the arm coupling member 34 of the right side frame 30 via a second lower support shaft 52a. The second lower support shaft 52a extends in the front-rear direction and is supported in an inserted state in the lower through hole 34d. The second lower support shaft 52a can rotate about an axis with respect to the right end portion of the second lower arm component 52 or can rotate about the axis with respect to the lower protruding plate section 34c. In other words, the right end portion of the second lower arm component 52 is coupled to the right side frame 30 in a manner to be rotatable about the shaft extending in the front-rear direction.

The right end portion of the first lower arm component 51 is coupled to a left portion of the lower coupling member 53 via a third lower support shaft 53a. The third lower support shaft 53a extends in the front-rear direction and is supported by the lower coupling member 53 while penetrating the right end portion of the first lower arm component 51 in the front-rear direction. The third lower support shaft 53a can rotate about an axis with respect to the right end portion of the first lower arm component 51 or can rotate about the axis with respect to the lower coupling member 53. In other words, the right end portion of the first lower arm component 51 is coupled to the lower coupling member 53 in a manner to be rotatable about the shaft extending in the front-rear direction.

The left end portion of the second lower arm component 52 is coupled to a right portion of the lower coupling member 53 via a fourth lower support shaft 53b. The fourth lower support shaft 53b extends in the front-rear direction and is supported by the lower coupling member 53 while penetrating the left end portion of the second lower arm component 52 in the front-rear direction. The fourth lower support shaft 53b can rotate about an axis with respect to the left end portion of the second lower arm component 52 or can rotate about the axis with respect to the lower coupling member 53. In other words, the left end portion of the second lower arm component 52 is coupled to the lower coupling member 53 in a manner to be rotatable about the shaft extending in the front-rear direction.

The upper support arm 40 is formed as a single arm by coupling the first upper arm component 41, the second upper arm component 42, and the upper coupling member 43. The lower support arm 50 is formed as a single arm by coupling the first lower arm component 51, the second lower arm component 52, and the lower coupling member 53. In addition, a left end portion of the upper support arm 40 and a left end portion of the lower support arm 50 are coupled to the left side frame 20. A right end portion of the upper support arm 40 and a right end portion of the lower support arm 50 are coupled to the right side frame 30. In this way, the left side frame 20, the right side frame 30, and a pair of the upper support arm 40 and the lower support arm 50 in the unfolded state form a truss structure as a structural framework under the seat 3. In the truss structure, all joints are hinged joints.

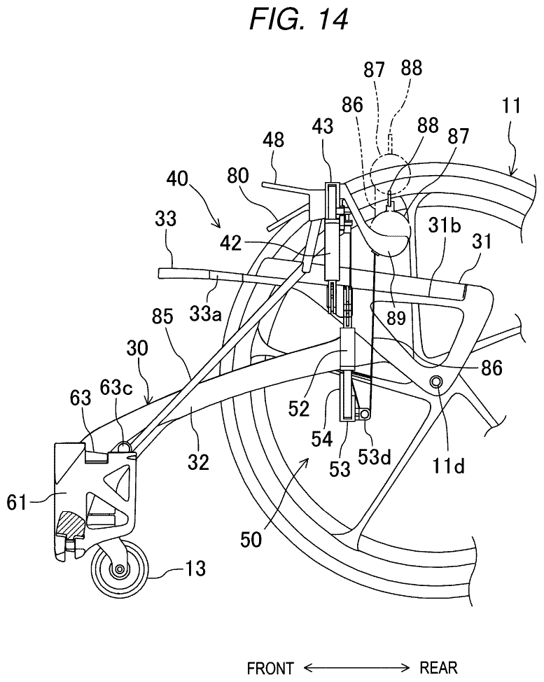

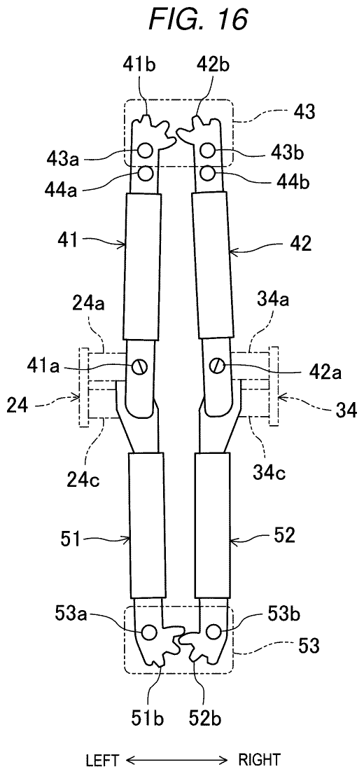

FIG. 16 illustrates a positional relationship in the folded state between the group including the first upper arm component 41 and the second upper arm component 42 and the group including the first lower arm component 51 and the second lower arm component 52. In this embodiment, the upper support arm 40 is folded when the first upper arm component 41 and the second upper arm component 42 rotate upward. Thus, the folding direction of the upper support arm 40 is the up direction. When being folded, the upper support arm 40 defines such a shape that forms the convexity in the up direction. Meanwhile, the lower support arm 50 is folded when the first lower arm component 51 and the second lower arm component 52 rotate downward. Thus, a folding direction of the lower support arm 50 is an opposite direction from the folding direction of the upper support arm 40, that is, the down direction. When being folded, the lower support arm 50 defines such a shape that forms a convexity in the down direction. In addition, as illustrated in FIG. 14, the upper support arm 40 is positioned in front of the lower support arm 50.

As illustrated in FIG. 15 and FIG. 16, in the right end portion of the first upper arm component 41, plural first upper teeth 41b are formed around the axis of the third upper support shaft 43a. In the left end portion of the second upper arm component 42, plural second upper teeth 42b are formed around the axis of the fourth upper support shaft 43b. The first upper teeth 41b and the second upper teeth 42b are disposed to mesh with each other. In the right end portion of the first lower arm component 51, plural first lower teeth 51b are formed around the axis of the third lower support shaft 53a. In the left end portion of the second lower arm component 52, plural second lower teeth 52b are formed around the axis of the fourth lower support shaft 53b. The first lower teeth 51b and the second lower teeth 52b are disposed to mesh with each other.

### Structure of Retaining Wheelchair Body in Folded State

In this embodiment, a retention mechanism is provided to retain the wheelchair body 2 in the folded state. By providing the retention mechanism, when being carried, the wheelchair body 2 in the folded state can easily be carried without being unexpectedly unfolded. The retention mechanism may also include a mechanism that retains the wheelchair body 2 in the unfolded state. This stabilizes the wheelchair body 2 in the unfolded state.

Hereinafter, the retention mechanism will be described in detail. For example, as illustrated in FIG. 10, the retention mechanism includes: a left pin (a first pin) 44a and a right pin (a second pin) 44b as a first engaged section provided to the upper support arm 40; an engaged plate (a second engaged section) 54 provided to the lower support arm 50; and an engagement section 70. The engaged section in this embodiment includes the first engaged section having the left pin 44a and the right pin 44b and the second engaged section having the engaged plate 54. However, the engaged section is not limited thereto and may only include one of the first engaged section and the second engaged section. That is, such a structure can be adopted that includes the engaged section provided to at least one of the upper support arm 40 and the lower support arm 50.

As also illustrated in FIG. 15 and FIG. 16, the left pin 44a protrudes rearward from a portion on the right side of a central portion of the first upper arm component 41 in the longitudinal direction, more specifically, from the left side of the third upper support shaft 43a. Meanwhile, the right pin 44b protrudes rearward from a portion on the left side of a central portion of the second upper arm component 42 in the longitudinal direction, more specifically, from the right side of the fourth upper support shaft 43b. The left pin 44a and the right pin 44b are parallel to each other.

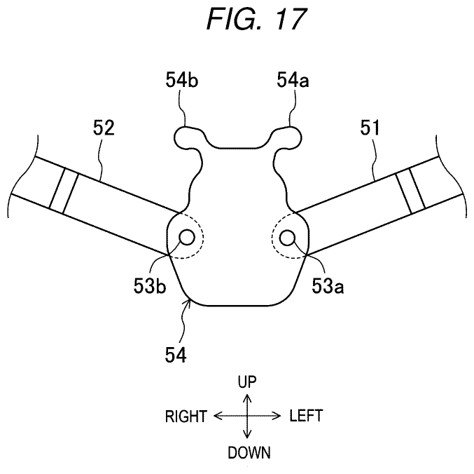

As enlarged in FIG. 17, the engaged plate 54 is disposed in front of the right end portion of the first lower arm component 51 and the left end portion of the second lower arm component 52, and is rotatably attached to the right end portion of the first lower arm component 51 and the left end portion of the second lower arm component 52. More specifically, a front end portion of the third lower support shaft 53a and a front end portion of the fourth lower support shaft 53b penetrate the engaged plate 54, and each of the third lower support shaft 53a and the fourth lower support shaft 53b can rotate about an axis with respect to the engaged plate 54. In this way, the first lower arm component 51 and the second lower arm component 52 are also coupled by the engaged plate 54 in a manner to be rotatable relative to each other.

A left protruding section 54a that protrudes leftward is formed in an upper left portion of the engaged plate 54. A right protruding section 54b that protrudes rightward is formed in an upper right portion of the engaged plate 54.

The engagement section 70 is a portion that engages the left pin 44a and the right pin 44b during folding of the upper support arm 40 and the lower support arm 50 and thereby prevents relative displacement in the up-down direction of the central portions of the upper support arm 40 and the lower support arm 50 in the left-right direction. In addition, the engagement section 70 engages the engaged plate 54 during unfolding of the upper support arm 40 and the lower support arm 50 and thereby prevents the relative displacement in the up-down direction of the central portions of the upper support arm 40 and the lower support arm 50 in the left-right direction.

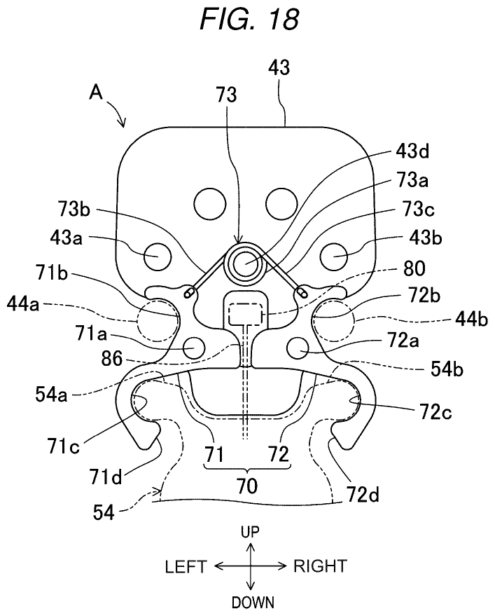

In this embodiment, the engagement section 70 is provided to the upper coupling member 43, and the engagement section 70 and the upper coupling member 43 are integrated. Thus, the engagement section 70 and the upper coupling member 43 can constitute a fixed section A (only illustrated in FIG. 18). In this case, the engagement section 70 provided in the fixed section A engages the pins 44a, 44b or the engaged plate 54 and thereby prevents the relative displacement in the up-down direction of the central portions of the upper support arm 40 and the lower support arm 50 in the left-right direction. However, the engagement section 70 and the upper coupling member 43 may not constitute the fixed section A.

As illustrated in FIG. 18, the engagement section 70 includes a left engagement member (a first engagement member) 71 and a right engagement member (a second engagement member) 72. The left engagement member 71 is supported by a portion on the left side of a central portion of the upper coupling member 43 in the left-right direction via a left rotary shaft 71a. The left rotary shaft 71a is disposed below the third upper support shaft 43a and near the central portion in the left-right direction, and extends in the front-rear direction. Accordingly, the left engagement member 71 can rotate about an axis of the left rotary shaft 71a.

In a portion above the left rotary shaft 71a in the left engagement member 71, an upper concave section 71b is formed to be opened leftward. In a portion below the left rotary shaft 71a in the left engagement member 71, a lower concave section 71c is formed to be opened rightward.

The right engagement member 72 is supported by a portion on the right side of the central portion of the upper coupling member 43 in the left-right direction via a right rotary shaft 72a. The right rotary shaft 72a is disposed below the fourth upper support shaft 43b and near the central portion in the left-right direction, and extends in the front-rear direction. Accordingly, the right engagement member 72 can rotate about an axis of the right rotary shaft 72a.

In a portion above the right rotary shaft 72a in the right engagement member 72, an upper concave section 72b is formed to be opened rightward. In a portion below the right rotary shaft 72a in the right engagement member 72, a lower concave section 72c is formed to be opened leftward.

The left pin 44a (indicated by an imaginary line in FIG. 18) enters the upper concave section 71b of the left engagement member 71 from the left side when the upper support arm 40 and lower support arm 50 are folded. Then, the left pin 44a that enters the upper concave section 71b engages and comes into contact with an inner surface of the upper concave section 71b. The right pin 44b (indicated by an imaginary line in FIG. 18) enters the upper concave section 72b of the right engagement member 72 from the right side when the upper support arm 40 and lower support arm 50 are folded. Then, the right pin 44b that enters the upper concave section 72b engages and comes into contact with an inner surface of the upper concave section 72b.

The left protruding section 54a of the engaged plate 54 enters the lower concave section 71c of the left engagement member 71 from a lower right side when the upper support arm 40 and lower support arm 50 are unfolded. Then, the left protruding section 54a that enters the lower concave section 71c engages and comes into contact with an inner surface of the lower concave section 71c. The right protruding section 54b of the engaged plate 54 enters the lower concave section 72c of the right engagement member 72 from a lower left side when the upper support arm 40 and lower support arm 50 are unfolded. Then, the right protruding section 54b that enters the lower concave section 72c engages and comes into contact with an inner surface of the lower concave section 72c. In FIG. 18, both of an engagement state during unfolding of the upper support arm 40 and the lower support arm 50 and an engagement state during folding thereof are indicated by the imaginary lines. However, in one of the engagement states, the other engagement state cannot be achieved in reality.

FIG. 18 illustrates a case where the left engagement member 71 is located at an engagement position at which the left engagement member 71 engages the left pin 44a and the left protruding section 54a. When the left engagement member 71 rotates rightward about the axis of the left rotary shaft 71a, the left engagement member 71 is positioned at a disengagement position at which the left engagement member 71 does not engage the left pin 44a and the left protruding section 54a. Similarly, FIG. 18 illustrates a case where the right engagement member 72 is located at an engagement position at which the right engagement member 72 engages the right pin 44b and the right protruding section 54b. When the right engagement member 72 rotates leftward about the axis of the right rotary shaft 72a, the right engagement member 72 is positioned at a disengagement position at which the right engagement member 72 does not engage the right pin 44b and the right protruding section 54b. In other words, each of the left engagement member 71 and the right engagement member 72 is supported by the upper coupling member 43 in a manner to be rotatable between the engagement position and the disengagement position.

The engagement section 70 includes a spring member 73 that urges each of the left engagement member 71 and the right engagement member 72 toward the engagement position. The spring member 73 is formed of a torsion spring and has an annular section 73a in a central portion thereof. A first arm 73b and a second arm 73c extend from the annular section 73a. In the central portion of the upper coupling member 43 in the left-right direction, a pin-shaped spring support section 43d is provided above the left rotary shaft 71a and the right rotary shaft 72a and protrudes rearward. By inserting the spring support section 43d in the annular section 73a of the spring member 73, the spring member 73 is retained in the upper coupling member 43.

The first arm 73b of the spring member 73 is locked to a portion above the left rotary shaft 71a in the left engagement member 71. The second arm 73c of the spring member 73 is locked to a portion above the right rotary shaft 72a in the right engagement member 72. The spring member 73 generates an urging force in a direction in which a distance between the first arm 73b and the second arm 73c is increased. As a result, each of the left engagement member 71 and the right engagement member 72 is urged toward the engagement position.

When the left pin 44a and the right pin 44b are engaged with the left engagement member 71 and the right engagement member 72, respectively, the left pin 44a and the right pin 44b approach the upper concave sections 71b, 72b by folding the upper support arm 40 and lower support arm 50 in the unfolded state, and enter the upper concave sections 71b, 72b while sliding against circumferential edges of the upper concave sections 71b, 72b, respectively. Since a folding force is greater than the urging force of the spring member 73, the left engagement member 71 and the right engagement member 72 rotate against the urging force of the spring member 73, and are then brought into the engagement state when the left pin 44a and the right pin 44b fully enter the upper concave sections 71b, 72b, respectively.

In addition, when the left protruding section 54a and the right protruding section 54b are engaged with the left engagement member 71 and the right engagement member 72, respectively, the left protruding section 54a and the right protruding section 54b approach the lower concave sections 71c, 72c by unfolding the upper support arm 40 and lower support arm 50 in the folded state, and enter the lower concave sections 71c, 72c while sliding against introduction surfaces 71d, 72d formed below the lower concave sections 71c, 72c, respectively. At this time, since an unfolding force is greater than the urging force of the spring member 73, the left engagement member 71 and the right engagement member 72 rotate against the urging force of the spring member 73, and are then brought into the engagement state when the left protruding section 54a and the right protruding section 54b fully enter the lower concave sections 71c, 72c, respectively.

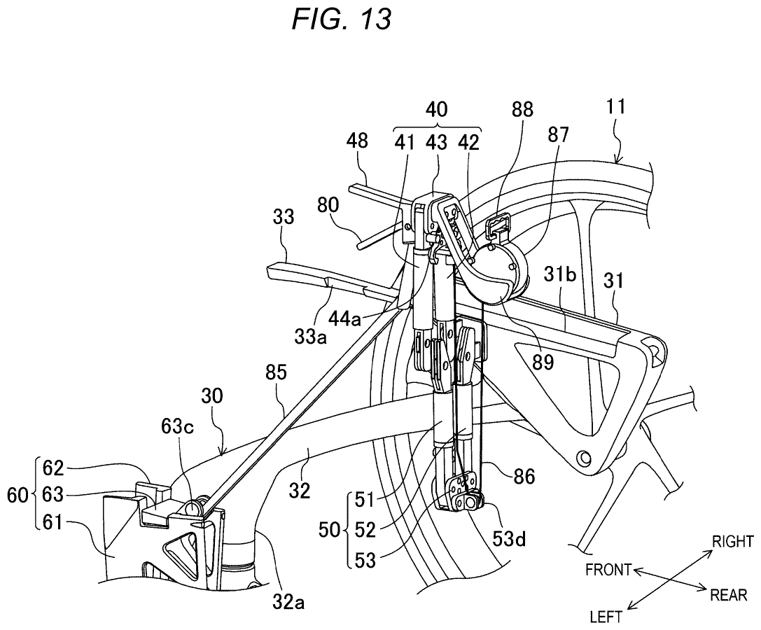

As illustrated in FIG. 11, FIG. 13, and the like, the wheelchair body 2 includes an operation section 80 for a switching operation of the engagement section 70 from the engagement state with the engaged section to the disengagement state. The operation section 80 is formed of a lever-like member that extends in the front-rear direction, and is provided to penetrate the upper coupling member 43 in the front-rear direction. An intermediate portion of the operation section 80 in the front-rear direction is rotatably attached to the upper coupling member 43 by an attachment shaft 80a (illustrated in FIG. 11) that extends in the left-right direction. In this way, the operation section 80 can freely swing about the attachment shaft 80a.

A front portion of the operation section 80 protrudes forward from a front surface of the upper coupling member 43. Meanwhile, a rear portion of the operation section 80 protrudes rearward from a rear surface of the upper coupling member 43. As indicated by an imaginary line in FIG. 18, the rear portion of the operation section 80 is disposed above a portion on the right side of the left rotary shaft 71a in the left engagement member 71 and above a portion on the left side of the right rotary shaft 72a in the right engagement member 72. When the operation section 80 is operated in a manner to lift the front portion of the operation section 80, the rear portion of the operation section 80 moves downward and presses the left engagement member 71 and the right engagement member 72 downward. When the left engagement member 71 and the right engagement member 72 are pressed downward by the rear portion of the operation section 80, the left engagement member 71 and the right engagement member 72 rotate to the disengagement positions against the urging force of the spring member 73. In this way, the left pin 44a and the right pin 44b can be disengaged from the left engagement member 71 and the right engagement member 72, respectively, and the left protruding section 54a and the right protruding section 54b can be disengaged from the left engagement member 71 and the right engagement member 72, respectively.

The upper coupling member 43 is provided with a handle 48. The handle 48 protrudes forward from the front surface of the upper coupling member 43 and is positioned above the front portion of the operation section 80. The wheelchair body 2 can be carried by holding the handle 48. In addition, a distance in the up-down direction between the handle 48 and the front portion of the operation section 80 is set such that the front portion of the operation section 80 can be lifted by hanging the front portion of the operation section 80 with fingers in a state of placing a palm of an adult hand on an upper surface of the handle 48, for example. In this way, the operation section 80 can easily be operated by using the handle 48. The handle 48 may protrude rearward.

### Coupling Structure of Support Arms and Footrest

In this embodiment, the folding direction and the unfolding direction of the upper support arm 40 match the folding direction and the unfolding direction of the footrest 60, respectively. Thus, a coupling structure is provided to couple the upper support arm 40 and the footrest 60 with a highly strong and highly rigid member. More specifically, the wheelchair 1 includes the rod 85 that connects the central portion of the upper support arm 40 in the left-right direction and the central portion of the footrest 60 in the left-right direction. The rod 85 is made of a member with high strength and high rigidity such as metal or the CFRP.

As illustrated in FIG. 9, a lower end portion (one end portion) of the rod 85 is coupled to the bracket 63 of the footrest 60 via the third coupling shaft 63c. Thus, the lower end portion of the rod 85 is only allowed to rotate about an axis of the third coupling shaft 63c with respect to the bracket 63. Meanwhile, an upper end portion (the other end portion) of the rod 85 is coupled to the front surface of the upper coupling member 43, which is located in the central portion of the upper support arm 40 in the left-right direction, in a manner not to move. As illustrated in FIG. 18, in the case where the upper coupling member 43 constitutes a part of the fixed section A, the rod 85 can be coupled to the first upper arm component 41 and the second upper arm component 42, which constitute the upper support arm 40, via the fixed section A.

When the wheelchair user is seated on the seat 3 in a state where the wheelchair body 2 is unfolded and the seat 3 is attached thereto (a state illustrated in FIG. 1), weight of the wheelchair user is applied to the left side frame 20 and the right side frame 30. In this way, a force in the unfolding direction is applied to the upper support arm 40 and the lower support arm 50. The force applied to the upper support arm 40 is transmitted to the central portion of the footrest 60 in the left-right direction via the rod 85. Since the upper support arm 40 is also unfolded in the same direction as the unfolding direction of the footrest 60, the force in the unfolding direction of the upper support arm 40 can be applied, as the force in the unfolding direction, to the footrest 60. In this way, the footrest 60 is maintained in the unfolded state. Thus, body rigidity can be improved by using the footrest 60.

The force that is applied to the upper support arm 40 by the seated wheelchair user is transmitted to the bracket 63 via the rod 85. As a result, the bracket 63 is held between the left footrest component 61 and the right footrest component 62 from both of the left and right sides. As a result, rattling of the footrest 60 is reduced, and thus the body rigidity is further improved.

### Unfolding Operation Assistance Mechanism

In this embodiment, an assistance mechanism for an unfolding operation is provided to facilitate the unfolding operation of the wheelchair body 2 during unfolding of the wheelchair body 2. As illustrated in FIG. 13 and FIG. 14, the wheelchair 1 includes: a wire (a tensioning member) 86 having a flexibility that is coupled to the upper support arm 40 and the lower support arm 50; a winding device 87 capable of winding the wire 86; and a grip section 88. It is configured that a predetermined tensile force input to the wire 86 can urge the upper support arm 40 and the lower support arm 50, each of which is in the folded state, in the unfolding direction.

The wire 86 is a member for applying a force in the unfolding direction to the upper support arm 40 and the lower support arm 50 in the folded state, and may be made of metal or resin. Instead of the wire 86, a member that is long and thin and can be bent or curved, such as a string, a thread, a chain, a rope, or a metal wire, may be used as the tensioning member.

As indicated by an imaginary line in FIG. 18, a distal end portion of the wire 86 is fixed to the rear portion of the operation section 80. In other words, since the operation section 80 is provided to the upper coupling member 43, the distal end portion of the wire 86 is coupled to the upper coupling member 43 via the rear portion of the operation section 80. Thus, the tensile force of the wire 86 is directly applied to the rear portion of the operation section 80.

As illustrated in FIG. 14 and the like, the wire 86 that is fixed to the rear portion of the operation section 80 extends downward, and the lowest end portion of the wire 86 is coupled to the lower coupling member 53 of the lower support arm 50. More specifically, a rear surface of the lower coupling member 53 is provided with a pulley 53d that rotates about an axis extending in the left-right direction, and the wire 86 is coupled to the lower coupling member 53 in a state where an intermediate portion of the wire 86 is wound around this pulley 53d. Instead of providing the pulley 53d, a guide member may be provided to the rear surface of the lower coupling member 53. The guide member prevents the intermediate portion of the wire 86 from being shifted in the left-right direction while allowing the intermediate portion of the wire 86 to slide against the guide member.

The upper coupling member 43 is provided with a pedestal section 89 on which the winding device 87 can be placed. The pedestal section 89 is formed to protrude rearward from the rear surface of the upper coupling member 43 and be lowered to the rear, and a rear portion of the pedestal section 89 has a shape that is recessed downward. By placing the winding device 87 in the recessed portion of the pedestal section 89, the winding device 87 is retained in a manner to prevent relative movement to the wheelchair body 2 in the left-right direction and the front-rear direction. In the folded state, the winding device 87 that is placed on the pedestal section 89 is positioned above and away from the pulley 53d.

The wire 86 that is wound around the pulley 53d extends upward and is then connected to a winding mechanism (not illustrated) that is provided inside the winding device 87. The winding device 87 is configured to be able to constantly apply a force in a winding direction to the wire 86, and any conventionally well-known winding mechanism can be used for the winding device 87. A winding force of the wire 86 by the winding device 87 (in other words, a force required to eject the wire 86) can be set as desired by the winding mechanism. In this embodiment, the winding force is set such that the wire 86 is ejected when the wire 86 is pulled downward by a lighter load than weight of the wheelchair body 2 (weight excluding the winding device 87). Although not illustrated, the winding device may be of an electric type. In the case where the winding device is of the electric type, the wire 86 can be wound by a motor or the like when a switch is operated, for example. Thus, there is no need to lift the winding device.

The grip section 88 provided on top of the winding device 87 is a portion that is gripped by the wheelchair user or the like when the wheelchair body 2 is unfolded. Since the grip section 88 is provided on top of the winding device 87, the grip section 88 can easily be gripped from above. Thus, the grip section 88 is attached, via the winding device 87, to an opposite side of the wire 86 from a side thereof that is coupled to the upper support arm 40 and the lower support arm 50.

When the folded wheelchair body 2 is unfolded, for example, the wheelchair user grips the grip section 88 to lift the winding device 87, and the wire 86 is then pulled upward. At this time, the wire 86 pulls the rear portion of the operation section 80 downward. Consequently, the operation section 80 is operated by the wire 86, and the left engagement member 71 and the right engagement member 72 each rotate to the disengagement position. In addition, the wire 86 is coupled to the central portions of the upper support arm 40 and the lower support arm 50 in the left-right direction. Accordingly, when the tensile force of the wire 86 becomes the predetermined tensile force, the upper support arm 40 is urged in the unfolding direction, and the lower support arm 50 is also urged in the unfolding direction. As a result, the upper support arm 40 and the lower support arm 50 are unfolded.

The winding device 87 is configured to be able to eject the wire 86 until the winding device 87 moves upward from the placement position (indicated by a solid line in FIG. 14), at which the winding device 87 is placed on the pedestal section 89, by a predetermined distance and is disposed at a departure position (indicated by an imaginary line in FIG. 14) away from the pedestal section 89. Since the wire 86 is flexible, a movement direction of the grip section 88 gripped by the wheelchair user is unlikely to be regulated by the upper support arm 40 and the lower support arm 50. Thus, the grip section 88 can move relatively freely. This allows the wheelchair user to input the predetermined tensile force while pulling the grip section 88 toward himself/herself and to move the grip section 88 to a position at which the wheelchair user can easily input the tensile force. As a result, the unfolding operation of the wheelchair body 2 is facilitated.

An ejection amount of the wire 86 by the winding device 87 is regulated such that the winding device 87 does not move upward from the placement position, at which the winding device 87 is placed on the pedestal section 89, by a longer distance than the predetermined distance. In other words, when a distance in the up-down direction between the placement position and the departure position is long, the winding device 87 has to be lifted to a higher position during the unfolding operation, which possibly makes the unfolding operation difficult, especially in the seated state. In order to handle such a problem, the ejection amount of the wire 86 is determined in advance to prevent the need for lifting the winding device 87 to the higher position during the unfolding operation. This further facilitates the unfolding operation.

When the lower support arm 50 is unfolded, the central portion of the lower support arm 50 in the left-right direction moves upward, and thus a distance between the pulley 53d and the winding device 87, which is placed on the pedestal section 89, is reduced. This results in the excess wire 86. However, since an excess portion of the wire 86 is wound by the winding device 87, the wire 86 is unlikely to become slack and tangled with another member or the like.

### Seat Attachment/Detachment Structure

As illustrated in FIG. 4, the seat 3 includes a seat cushion section 91, on which the wheelchair user is seated, a back cushion section 92, and a seat frame 90. The seat frame 90 is provided to a lower portion of the seat 3 and is configured to be attachable to the left side frame 20 and the right side frame 30 from above.

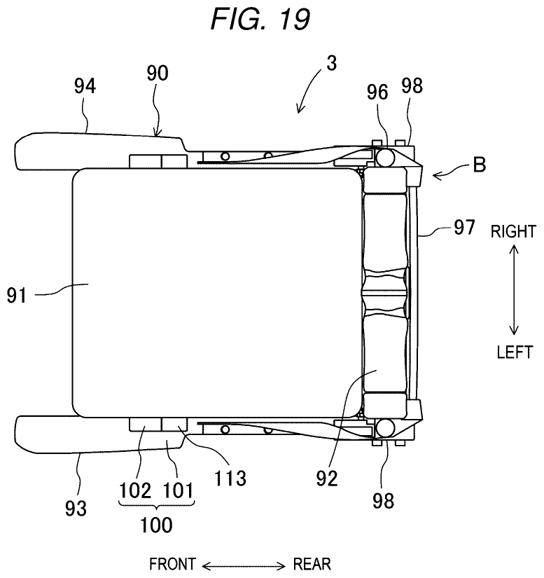

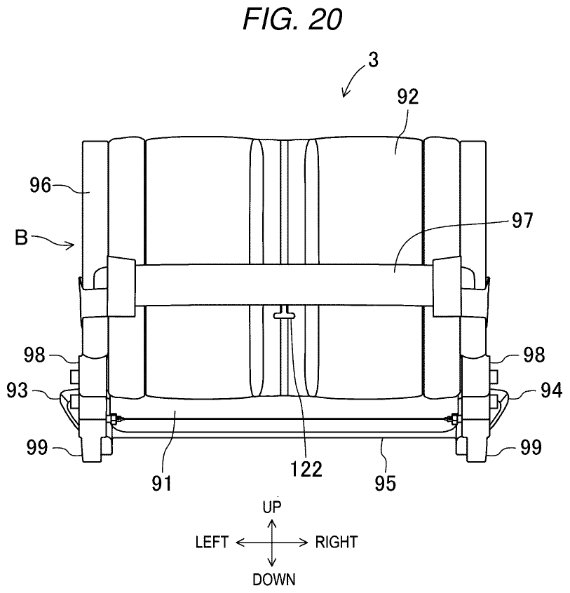

As illustrated in FIG. 19 and FIG. 20, the seat frame 90 includes: the left frame section 93 that is provided to the lower portion of the seat 3 and extends in the front-rear direction in a left portion of the seat 3; the right frame section 94 that is provided to the lower portion of the seat 3 and extends in the front-rear direction in a right portion of the seat 3; and a coupling frame section 95 (illustrated in FIG. 20) that extends between the left frame section 93 and the right frame section 94 and couples the left frame section 93 and the right frame section 94. The left frame section 93 is a portion that is accommodated in the left seat frame accommodation section 21b and supported by the seat support plate section 23, and can be attached/detached to/from the upper frame section 21 of the left side frame 20. The right frame section 94 is a portion that is accommodated in the right seat frame accommodation section 31b and supported by the seat support plate section 33, and can be attached/detached to/from the upper frame section 31 of the right side frame 30.

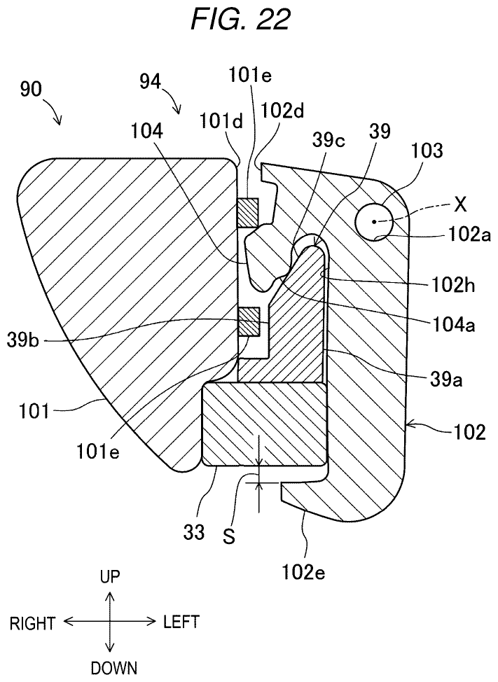

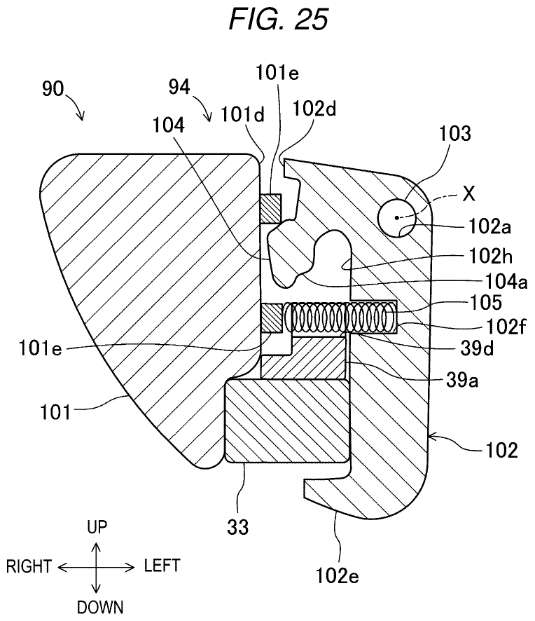

Since the left frame section 93 and the right frame section 94 have a bilaterally-symmetrical structure, the right frame section 94 will be described in detail below. As illustrated in FIG. 22 and FIG. 25, the right frame section 94 is configured to hold the seat support plate section 33 from the left and right sides while being supported by the seat support plate section 33. The left surface and a right surface of this seat support plate section 33 are parallel to each other and extend in the up-down direction. A lower surface of the seat support plate section 33 extends in the left-right direction and the front-rear direction.

The right frame section 94 includes a frame abutment section 101, an abutment member 102, and a shaft member 103. The frame abutment section 101 is integrally molded into a body portion of the right frame section 94. Although the frame abutment section 101 and the abutment member 102 are illustrated to be solid in FIG. 22, the frame abutment section 101 and the abutment member 102 may be hollow. The frame abutment section 101 is formed by a portion of the right frame section 94 in the front-rear direction and is disposed to abut the right surface of the seat support plate section 33 from the right side. The abutment member 102 is a member that abuts the left surface of the seat support plate section 33 from the left side and is disposed on the inner side of the seat frame 90 in the body width direction. A lower portion of the abutment member 102 is disposed in the concave section 33a (illustrated in FIG. 8) of the seat support plate section 33.

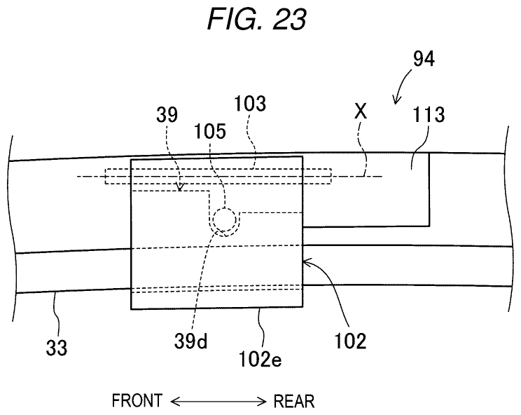

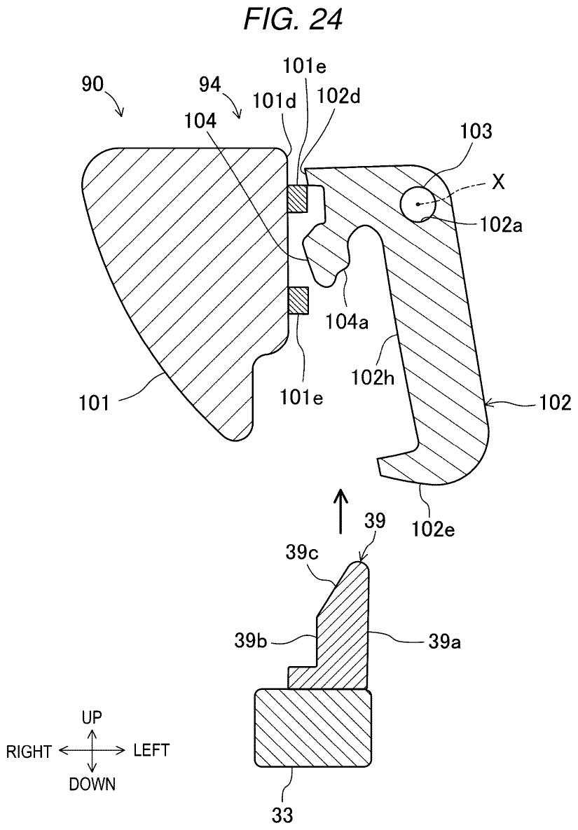

As illustrated in FIG. 23, the abutment member 102 has a block shape and is supported by the shaft member 103 to be rotatable about an axis X extending in the front-rear direction with respect to an upper portion of the frame abutment section 101. FIG. 24 illustrates a state where the abutment member 102 rotates in a direction away from the frame abutment section 101 (the left direction). As illustrated in FIG. 22, an upper left portion (a portion on the inner side in the vehicle width direction) of the abutment member 102 is formed with a shaft through hole 102a that penetrates the shaft member 103. As indicated by broken lines in FIG. 23, the shaft member 103 is set to be longer than a dimension in the front-rear direction of the abutment member 102, a front end portion of the shaft member 103 protrudes forward from a front surface of the abutment member 102, and a rear end portion of the shaft member 103 protrudes rearward from a rear surface of the abutment member 102.

The front end portion and the rear end portion of the shaft member 103 are each supported by the body portion of the right frame section 94. The front end portion of the shaft member 103 is supported by a portion of the right frame section 94 that is located in front of the abutment member 102, and the rear end portion of the shaft member 103 is supported by a portion of the right frame section 94 that is located behind the abutment member 102. The front end portion and the rear end portion of the shaft member 103 may be supported by the body portion of the right frame section 94 in the manner to be rotatable about the axis X, or the abutment member 102 may be supported by the shaft member 103 in a manner to be rotatable about the axis X.

As illustrated in FIG. 25, the right frame section 94 is provided with an urging member 105 that constantly urges the abutment member 102 in a direction away from the frame abutment section 101. The urging member 105 is formed of a coil spring that is disposed between the frame abutment section 101 and the abutment member 102 in a manner that a compression direction of the coil spring is oriented in the left-right direction. The urging member 105 separates downward from the shaft member 103. A left portion of the urging member 105 is accommodated in a spring accommodation section 102f that is formed in the abutment member 102. The spring accommodation section 102f is configured as a concave portion that is opened to a right surface of the abutment member 102. The left end portion of the urging member 105 abuts a bottom surface of the spring accommodation section 102f. In a state where a left portion of the urging member 105 is accommodated in the spring accommodation section 102f, the urging member 105 is held by an inner surface of the spring accommodation section 102f. This suppresses falling of the urging member 105.

A right end portion of the urging member 105 abuts an intermediate portion of the frame abutment section 101 in the up-down direction. Accordingly, an urging force of the urging member 105 is applied in the left-right direction in the portion that separates downward from the shaft member 103. Thus, the urging force is a force that causes rotation of the abutment member 102 about the axis X in the left direction. Here, the urging member 105 is not limited to the coil spring, and may be formed of an elastic member such as a string spring, an elastomer, or rubber.

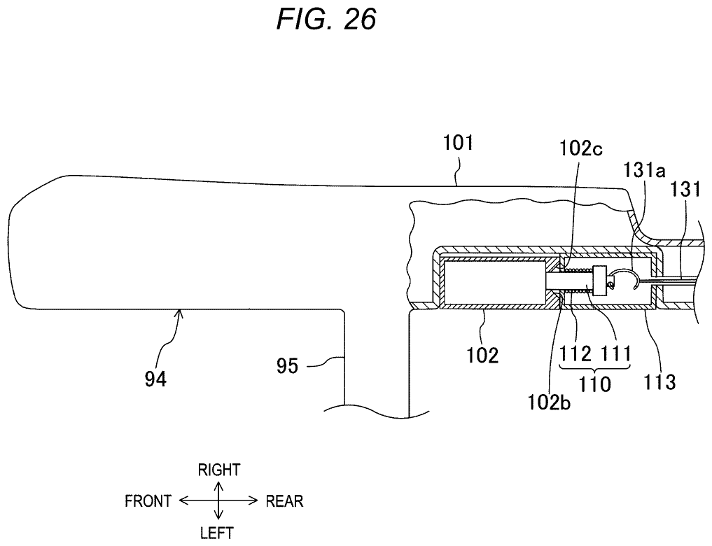

As illustrated in FIG. 26, the right frame section 94 has a locking section 110 that locks the abutment member 102 in an abutment state with the seat support plate section 33. The locking section 110 has a lock pin 111 and a coil spring 112. The lock pin 111 and the coil spring 112 are disposed on the rear side of the abutment member 102.

The right frame section 94 is provided with a lock pin accommodation box 113 that is adjacent to the rear side of the abutment member 102. Inside the lock pin accommodation box 113, the lock pin 111 is disposed in a posture extending in the front-rear direction. The lock pin 111 is supported by the lock pin accommodation box 113 in a manner to be movable in the front-rear direction, and can be switched between an advanced state where a front end portion (a distal end portion) of the lock pin 111 protrudes from a front surface of the lock pin accommodation box 113 and a retracted state where the front end portion of the lock pin 111 does not protrude from the front surface of the lock pin accommodation box 113.

The coil spring 112 is also accommodated in the lock pin accommodation box 113. One end portion of the coil spring 112 is retained inside the lock pin accommodation box 113, and the other end portion of the coil spring 112 engages the lock pin 111. In this state, the coil spring 112 urges the lock pin 111 in an advancing direction.

A rear wall portion of the abutment member 102 is formed with a hole 102b in which the distal end portion of the lock pin 111 is inserted. A radial center of the hole 102b is positioned to coincide with an axis of the lock pin 111 in a state where the abutment member 102 abuts the seat support plate section 33. Since an urged direction of the lock pin 111 by the coil spring 112 is the front direction, the urged direction coincides with a direction in which the distal end portion of the lock pin 111 is inserted in the hole 102b. By inserting the distal end portion of the lock pin 111 in the hole 102b, the abutment member 102 does not rotate in the left-right direction and is locked in an abutment state with the seat support plate section 33.

An inner surface of the hole 102b is provided with a guide surface 102c that guides the lock pin 111 into the hole 102b. The guide surface 102c is provided in a rear portion of the inner surface of the hole 102b, that is, a portion on the front side in the insertion direction of the lock pin 111 with the insertion direction being a reference. The guide surface 102c is formed as a tapered surface, an inner diameter of which is increased toward the front side in the insertion direction. The guide surface 102c may be provided as needed. For example, although not illustrated, a diameter of the lock pin 111 may be reduced toward the distal end. This can exert the same effect as that in the case of providing the guide surface 102c, that is, such an effect that the lock pin 111 is reliably inserted in the hole 102b and thus can lock the abutment member 102.

As illustrated in FIG. 22 and FIG. 24, a convex section 39 is provided to an upper surface of the seat support plate section 33 of the right side frame 30 in a manner to protrude upward. The convex section 39 is formed of a different member from the seat support plate section 33 and is fixed to the seat support plate section 33 by using a fastening member (not illustrated) or the like. However, the convex section 39 may be integrally molded into the seat support plate section 33.

The convex section 39 is a portion that presses the abutment member 102 from below and thereby causes the abutment member 102 to rotate in the direction, in which the portion of the abutment member 102 below the axis X abuts the seat support plate section 33 of the right side frame 30, when the seat frame 90 is attached to the side frames 20, 30. More specifically, while a left surface 39a of the convex section 39 extends in the up-down direction from an upper portion to a lower portion of the convex section 39, an upper portion of a right surface 39b of the convex section 39 is configured as an inclined surface 39c inclined to a vertical plane such that the inclined surface 39c is located leftward to an upper end.

The upper portion of the abutment member 102 is provided with a protruding section 104 that protrudes in a direction away from the axis X, that is, rightward and downward. A convex surface 104a that protrudes downward and leftward is formed on a left surface of the protruding section 104. The convex surface 104a is located above a lower end portion of the protruding section 104. A distance in the left-right direction between the convex surface 104a and an inner surface 102h of the abutment member 102 is set such that the convex section 39 of the right side frame 30 can be disposed therebetween.

An upper end portion 102d on the right side of the abutment member 102 is formed to separate leftward from an upper end portion 101d on the left side of the frame abutment section 101. In this way, a clearance for allowing the rotation of the abutment member 102 is provided between the upper end portion 102d on the right side of the abutment member 102 and the upper end portion 101d on the left side of the frame abutment section 101.

A rib-shaped section 101e that extends in the front-rear direction is provided on a left surface of the frame abutment section 101. As illustrated in FIG. 25, the right end portion of the urging member 105 abuts the rib-shaped section 101e. This rib-shaped section 101e may be provided as needed, and may not be provided.

As illustrated in FIG. 24, when the seat frame 90 is attached to the right side frame 30, the seat frame 90 is disposed above the right side frame 30 and thereafter moves downward. The convex section 39 is disposed to press a portion of the abutment member 102 on the right side (one side in the left-right direction) of the axis X. More specifically, a position of the convex section 39 is set such that the inclined surface 39c of the convex section 39 abuts the convex surface 104a of the abutment member 102 and presses the convex surface 104a upward.

As illustrated in FIG. 22, the abutment member 102 extends to a position below the seat support plate section 33 along the left surface of the seat support plate section 33 of the right side frame 30. A lower end portion of the abutment member 102 is formed with a protruding section 102e that is disposed to protrude rightward (one side in the left-right direction) and oppose the lower surface of the seat support plate section 33. A predetermined space S (illustrated in FIG. 22) is provided between the protruding section 102e of the abutment member 102 and the lower surface of the seat support plate section 33.

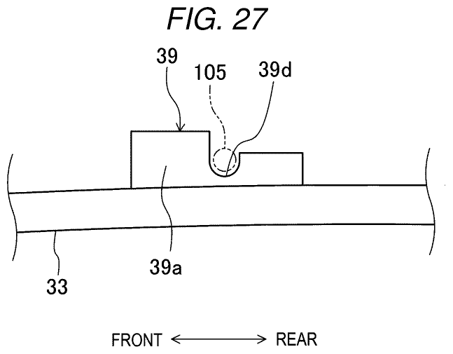

In addition, as illustrated in FIG. 23 and FIG. 27, an intermediate portion of the convex section 39 in the front-rear direction is formed with a notched section 39d in which an intermediate portion of the urging member 105 in the left-right direction can be accommodated. The notched section 39d is opened upward. When the convex section 39 is inserted between the convex surface 104a and the inner surface 102h of the abutment member 102, the urging member 105 is accommodated in the notched section 39d from an open portion of the notched section 39d.

Thus, in a state before the seat frame 90 is attached to the right side frame 30, as illustrated in FIG. 24, the abutment member 102 rotates about the axis X in the left direction and is stopped. This stop position is set appropriately and can be set by providing a member such as a stopper. In the state where the abutment member 102 has rotated leftward, a distance between the abutment member 102 and the frame abutment section 101 is increased. Thus, the convex section 39 can easily be inserted between the abutment member 102 and the frame abutment section 101.

Then, when the right frame section 94 of the seat frame 90 is disposed above the right side frame 30 and then moves downward during the attachment of the seat frame 90 to the right side frame 30, the convex section 39 presses the portion of the abutment member 102 on the right side of the axis X upward from below. Consequently, the abutment member 102 rotates about the axis X in the right direction. A rotation amount of the abutment member 102 in the right direction corresponds to an insertion amount of the convex section 39 between the convex surface 104a and the inner surface 102h. Thus, as the convex section 39 is deeply inserted between the convex surface 104a and the inner surface 102h, the rotation amount of the abutment member 102 in the right direction is increased.

A shape and a size of the convex section 39, the space S between the protruding section 102e and the lower surface of the seat support plate section 33, and the like are set such that the lower surface of the seat support plate section 33 is located above the protruding section 102e of the abutment member 102 at a stage immediately before the right frame section 94 is placed on the seat support plate section 33. Thus, even in the case where the protruding section 102e has the shape that protrudes rightward, the protruding section 102e does not interfere with the left surface of the seat support plate section 33 until the right frame section 94 is completely placed on the seat support plate section 33.

Thereafter, until the right frame section 94 is completely placed on the seat support plate section 33, the protruding section 102e rotates to the position at which the protruding section 102e opposes the lower surface of the seat support plate section 33. Then, at the stage where the right frame section 94 is completely placed on the seat support plate section 33, the protruding section 102e is disposed right below the seat support plate section 33 as illustrated in FIG. 22, the lock pin 111, which is urged by the coil spring 112, is inserted in the hole 102b of the abutment member 102 as illustrated in FIG. 26, and the abutment member 102 is thereby locked.

As illustrated in FIG. 22, the protruding section 102e is disposed right below the seat support plate section 33. Thus, when the seat support plate section 33, which is held by the frame abutment section 101 and the abutment member 102, moves downward to be removed from the position between the frame abutment section 101 and the abutment member 102 in the attachment state of the seat 3, the protruding section 102e of the abutment member 102 contacts the lower surface of the seat support plate section 33. This ensures that the seat support plate section 33 is not unexpectedly removed from the position between the frame abutment section 101 and the abutment member 102.

As it has been described so far, the right frame section 94 can move downward until the right frame section 94 is completely placed on the seat support plate section 33. In other words, the right frame section 94 moves downward until being placed on the seat support plate section 33. Thereafter, a downward load that is applied to the right frame section 94 when the wheelchair user is seated on the seat 3 is almost entirely received by the upper surface of the seat support plate section 33 and is hardly applied to the abutment member 102 and the shaft member 103.

Meanwhile, when the abutment member 102 rotates rightward until the right frame section 94 is completely placed on the seat support plate section 33, the lower portion of the right surface of the abutment member 102 abuts the right surface of the seat support plate section 33, and the seat support plate section 33 is held in the left-right direction by the frame abutment section 101 and the abutment member 102. This can facilitate the attachment of the seat 3 and suppress rattling of the attached seat 3.

As illustrated in FIG. 4, FIG. 19, FIG. 20, and the like, the seat 3 has a seat back frame 96 that supports the back cushion section 92. The back cushion section 92 and the seat back frame 96 constitute a seat back section B.

A cross member 97 that extends in the left-right direction is provided in an intermediate portion of the seat back frame 96 in the up-down direction. A lower end portion of the seat back frame 96 is supported by a rear end portion of the seat frame 90 via a tilting section 98. The tilting section 98 is a portion that can tilt the seat back frame 96 forward. A pressing section 99 is provided on each of the left and right sides of lower portions of the tilting sections 98. The pressing section 99 presses respective one of the rear end portion of the upper frame section 21 of the left side frame 20 and the rear end portion of the upper frame section 31 of the right side frame 30 from behind.

When the seat 3 is detached from the left side frame 20 and the right side frame 30, the pressing sections 99 are released from the rear end portions of the upper frame sections 21, 31 by tilting the seat back frame 96 forward. When the seat 3 is attached, an operation is performed to set the seat back frame 96, which is tilted forward, rearward. In this way, the pressing sections 99 press the rear end portions of the upper frame sections 21, 31, thereby preventing rattling of the seat 3.

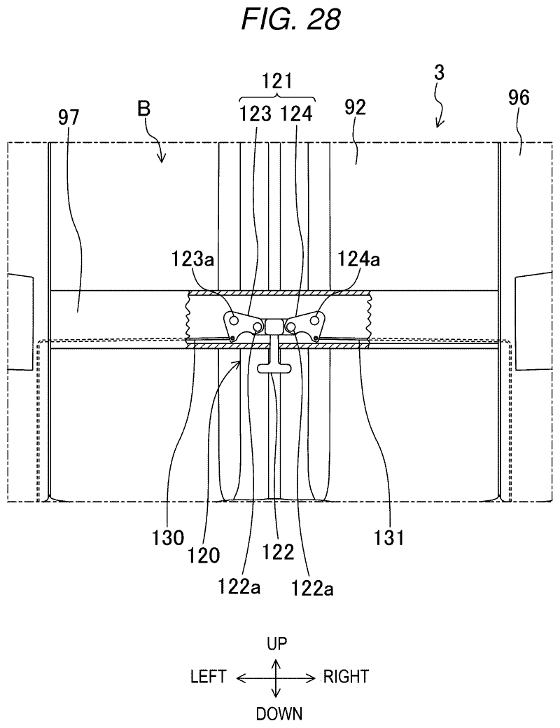

As illustrated in FIG. 28, the cross member 97 in the seat back section B is provided with an unlocking operation section 120. The unlocking operation section 120 includes: an unlocking mechanism 121 that is provided in a central portion of the cross member 97 in the left-right direction; and an unlocking lever 122 that is provided to protrude downward from the cross member 97. The unlocking mechanism 121 includes a left swing member 123 and a right swing member 124 that are respectively supported by support shafts 123a, 124a in a manner to be freely swingable in the up-down direction with respect to the cross member 97. The unlocking lever 122 is disposed in a posture extending in the up-down direction, and an upper end portion of the unlocking lever 122 is rotatably coupled to the left swing member 123 and the right swing member 124 via rotary shafts 122a. Accordingly, when the unlocking lever 122 moves upward, the left swing member 123 and the right swing member 124 swing upward about the support shafts 123a, 124a, respectively.

A base end portion of a right operation wire 131 for operating the lock pin 111 is connected to a portion below the support shaft 124a in the right swing member 124. The right operation wire 131 runs through the cross member 97 and the seat back frame 96, and reaches the inside of the right frame section 94 as illustrated in FIG. 26. A distal end portion of the right operation wire 131 is connected to a base end portion of the lock pin 111 via a connection member 131a. In other words, since the locking section 110 is coupled to the unlocking operation section 120 via the right operation wire 131, an urging force of the coil spring 112 is applied to the right operation wire 131.

In addition, since the lock pin 111 is disposed on the rear side of the abutment member 102, the lock pin 111 and the unlocking operation section 120 can be brought close to each other. As a result, a length of the right operation wire 131 can be reduced, which facilitates handling of the right operation wire 131 and thus ensures favorable operability during unlocking.

When the right swing member 124 swings upward by the unlocking lever 122, the right operation wire 131 is pulled, and a pulling force of this right operation wire 131 is applied to the lock pin 111 in a removal direction (an unlocking direction) from the hole 102b.

As illustrated in FIG. 28, similar to the right side, a left operation wire 130 is connected to the left swing member 123. This left operation wire 130 is a member for unlocking a left lock pin (not illustrated). In this embodiment, the left frame section 93 and the right frame section 94 have a bilaterally-symmetrical structure. However, the abutment member 102 may not be provided to one thereof.

Meanwhile, when the seat 3 is detached, the unlocking operation section 120 is operated, and an operating force thereof is transmitted to the lock pin 111 via the right operation wire 131 for unlocking. At this time, since the unlocking operation section 120 is provided to the seat back section B, which is positioned higher than the seat cushion section 91, the favorable operability of the unlocking operation section 120 is ensured.

When the seat 3 is pulled upward and lifted in an unlocked state of the abutment member 102, the convex section 39 moves downward relative to the abutment member 102 due to the provision of the space S (illustrated in FIG. 22) between the protruding section 102e and the lower surface of the seat support plate section 33. Then, the abutment member 102 rotates about the axis X in the left direction by the urging force of the urging member 105, and the protruding section 102e moves to the left side of the seat support plate section 33. Thus, the convex section 39 can completely be removed. Even when the protruding section 102e is provided, just as described, the seat 3 does not interfere with the protruding section 102e during the attachment and the detachment of the seat 3 due to the provision of the space S.

The above-described embodiment is merely illustrative in all respect and thus should not be construed in a restrictive manner. Furthermore, modifications and changes that fall within the claims and equivalents thereof fall within the scope of the present disclosure.

As it has been described herein, the wheelchair according to the present disclosure can be used, for example, when being carried in an automobile or the like.

What is claimed is:

1. A folding wheelchair including a seat on which a wheelchair user can be seated, the wheelchair comprising:
a left side frame that axially supports a drive wheel on a left side of a body;
a right side frame that axially supports a drive wheel on a right side of the body; and
a support arm that couples the left side frame and the right side frame and is foldable, wherein
the seat has a seat frame that is configured to be attachable to the left side frame and the right side frame from above,
the seat frame has a frame abutment section that abuts at least one side frame of the left side frame and the right side frame from one side in a left-right direction; an abutment member that abuts the one of the side frames from the other side in the left-right direction; and a shaft member that supports the abutment member in a manner to allow rotation of the abutment member about an axis extending in a body front-rear direction with respect to a body portion of the seat frame, and
the one of the side frames has a convex section in a manner to protrude upward, the convex section pressing the abutment member from below during attachment of the seat frame to cause the abutment member to rotate in a direction in which a portion of the abutment member below the axis abuts the one of the side frames.

2. The wheelchair according to claim 1, wherein
the convex section is disposed to press a portion of the abutment member on one side in the left-right direction of the axis during the attachment of the seat frame.

3. The wheelchair according to claim 1, wherein
the seat frame has an urging member that constantly urges the abutment member in a direction away from the frame abutment section.

4. The wheelchair according to claim 3, wherein
the abutment member extends to a position below the one of the side frames along a side surface of the one of the side frames, and
a lower end portion of the abutment member comprises a protruding section that is disposed to protrude to one side in the left-right direction and oppose a lower surface of the one of the side frames.

5. The wheelchair according to claim 4, wherein
a predetermined space is provided between the protruding section of the abutment member and the lower surface of the one of the side frames.

6. The wheelchair according to claim 3, wherein
the urging member comprises a coil spring that is disposed between the frame abutment section and the abutment member in a manner that a compression direction is oriented in the left-right direction, and
an intermediate portion of the convex section in the body front-rear direction comprises a notched section in which an intermediate portion of the coil spring in the left-right direction is accommodated.

7. The wheelchair according to claim 6, further comprising a lock pin disposed inside of the one of the side frames, the lock pin movable in in the body front-rear direction and urged to the front direction by a coil spring;
wherein when a seat support plate section is held by the frame abutment section and the abutment member, the lock pin is inserted in a hole of the abutment member and urged by the coil spring to lock the abutment member in place.

8. The wheelchair according to claim 7, further comprising a seat back supported by a rear end portion of the seat frame via a tilting section;
a locking lever in the seat back frame which pulls a locking mechanism;
an unlocking operation section provided in the seat back including an unlocking lever and a swing member actuated by operation of the unlocking lever; and
a wire connecting the lock pin and the swing member;
wherein operation of the unlocking lever causes a pulling force of the wire to remove the lock pin from the hole of the abutment member and the seat to be released from the seat support plate section.
